(19) United States
(12) Patent Application Publication
(10) Pub. No.: US 2021/0336707 A1
(43) Pub. Date: Oct. 28, 2021

(54) DOWNLINK SIGNAL AND NOISE CONTROL TO TEST USER EQUIPMENT PERFORMANCE REQUIREMENTS

(71) Applicant: INTEL CORPORATION, Santa Clara, CA (US)

(72) Inventors: Andrey Chervyakov, Nizhny Novgorod (RU); Dmitry Belov, Nizhny Novgorod (RU); Artyom Putilin, Kstovo (RU); Alexey Khoryaev, Nizhny Novgorod (RU); Yang Tang, Santa Clara, CA (US)

(21) Appl. No.: 17/264,676

(22) PCT Filed: Aug. 8, 2019
(86) PCT No.: PCT/US2019/045651

§ 371 Date: Jan. 29, 2021

Related U.S. Application Data
(60) Provisional application No. 62/805,861, filed on Feb. 14, 2019.
(60) Provisional application No. 62/717,714, filed on Aug. 10, 2018.

(51) Int. Cl. H04B 17/00; H04B 17/336; H04B 17/29; H04L 27/26

(52) U.S. Cl. CPC H04B 17/0085; H04L 27/26025; H04B 17/29; H04B 17/336

(57) ABSTRACT

Systems and methods provide for testing receiver (Rx) performance requirements of a user equipment (UE). Test equipment is configured to generate a radio frequency (RF) signal with a power level (Es) and determine a power spectral density (Noc) for an artificial noise signal. The Es and Noc may be selected to emulate a target signal-to-noise ratio (SNR) at a baseband Rx chain of the UE and to compensate for UE RF noise. The RF signal and the noise signal may be combined to produce an applied signal provided to the UE for testing.

### CROSS-REFERENCE TO RELATED APPLICATIONS

This application claims the benefit of U.S. Provisional Application No. 62/717,174, filed Aug. 10, 2018 and 62/805,861, filed Feb. 14, 2019, each of which is hereby incorporated by reference herein in its entirety.

### TECHNICAL FIELD

This application relates generally to wireless communication systems, and more specifically to testing user equipment (UE).

### BACKGROUND

Wireless mobile communication technology uses various standards and protocols to transmit data between a base station and a wireless mobile device. Wireless communication system standards and protocols can include the 3rd Generation Partnership Project (3GPP) long term evolution (LTE); fifth-generation (5G) 3GPP new radio (NR) standard; the Institute of Electrical and Electronics Engineers (IEEE) 802.16 standard, which is commonly known to industry groups as worldwide interoperability for microwave access (WiMAX); and the IEEE 802.11 standard for wireless local area networks (WLAN), which is commonly known to industry groups as Wi-Fi. In 3GPP radio access networks (RANs) in LTE systems, the base station can include a RAN Node such as a Evolved Universal Terrestrial Radio Access Network (E-UTRAN) Node B (also commonly denoted as evolved Node B, enhanced Node B, eNodeB, or eNB) and/or Radio Network Controller (RNC) in an E-UTRAN, which communicate with a wireless communication device, known as user equipment (UE). In fifth generation (5G) wireless RANs, RAN Nodes can include a 5G Node, new radio (NR) node or g Node B (gNB), which communicate with a wireless communication device, also known as user equipment (UE).

### BRIEF DESCRIPTION OF THE SEVERAL VIEWS OF THE DRAWINGS

FIG. 1 illustrates a test system in accordance with one embodiment.

FIG. 2 illustrates a test system in accordance with one embodiment.

FIG. 3 illustrates a test system in accordance with one embodiment.

FIG. 4 illustrates a test system in accordance with one embodiment.

FIG. 5 illustrates a test system in accordance with one embodiment.

FIG. 6 illustrates a graph in accordance with one embodiment.

FIG. 7 illustrates a baseline measurement setup in accordance with one embodiment.

FIG. 8, FIG. 9, and FIG. 10 illustrate an example test setup in accordance with various embodiments.

FIG. 11 illustrates a system in accordance with one embodiment.

FIG. 12 illustrates a system in accordance with one embodiment.

FIG. 13 illustrates a device in accordance with one embodiment.

FIG. 14 illustrates an example interfaces in accordance with one embodiment.

### DETAILED DESCRIPTION

Certain embodiments disclosed herein provide methods for controlling a downlink (DL) signal-to-noise ratio (SNR) for new radio (NR) UE during the UE test procedure. A first section of this disclosure includes embodiments for DL SNR, desired signal power level (Es) and artificial noise power spectral density (Noc) control for NR UE performance requirements test methodology. A second section of this disclosure includes additional embodiments for DL SNR control for NR millimeter wave (mmWave) over-the-air (OTA) UE demodulation and channel state information (CSI) reporting performance requirements test methodology.

### I. SNR, ES AND NOC CONTROL FOR NR UE PERFORMANCE REQUIREMENTS TEST METHODOLOGY

In legacy implementations (e.g. in LTE), to ensure proper UE performance, 3GPP defines minimum UE Demodulation and CSI reporting performance requirements. The respective NR UE Demodulation and CSI reporting performance requirements are defined in the 3GPP TS 38.101-4 and used as the basis for the definition of the UE conformance tests.

NR wireless communication systems support operation in FR1 (frequency range 1) which spans the carrier frequencies from 410 MHz to 7125 MHz and in FR2 (frequency range 2), which spans the carrier frequencies from 24.25 GHz to 52.60 GHz and is also known as mmWave range.

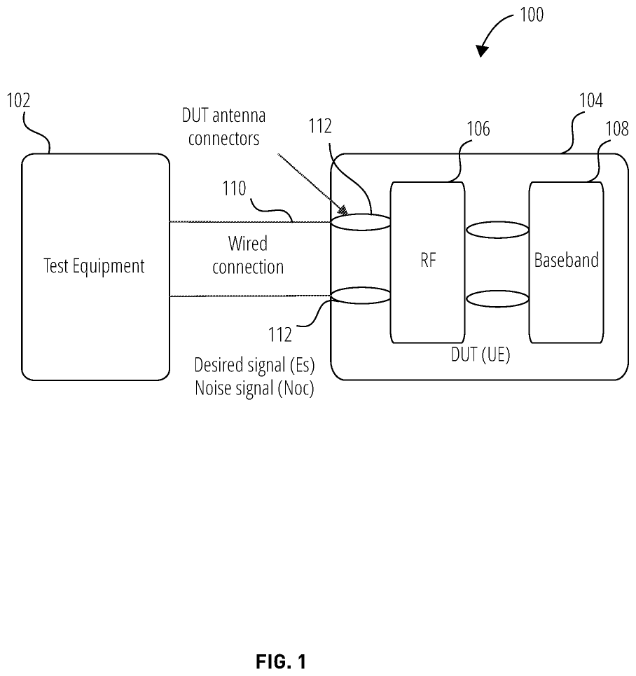

For NR technology two general UE test methodologies for UE performance testing (e.g., testing of UE demodulation and CSI reporting performance) are considered. A first methodology is based on conducted testing principles, when the test system has a wired connection to the conducted antenna connectors of the device under test (DUT), wherein the respective method is applicable for NR FR1 device testing. For example, FIG. 1 illustrates a test system 100 for the conducted test methodology according to one embodiment. The test system 100 includes test equipment 102, a DUT 104 (e.g., UE), radio frequency (RF) components of the Rx chain (RF 106), and baseband (BB) components of the Rx chain (baseband 108). The test system 100 includes a wired connection 110 to the DUT's conducted antenna connectors 112. The test equipment 102 of the test system 100 may include, for example a base station (BS) emulator, a propagation channel emulator, and dedicated equipment for performance measurement. The DUT 104 for conducted testing typically represent a chipset implementation which includes RF and BB components of the UE.

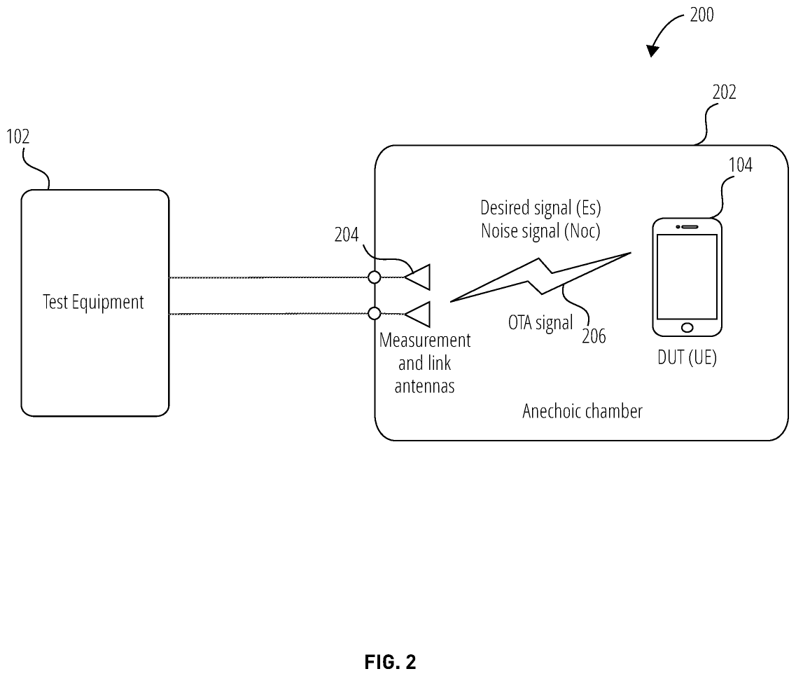

A second methodology is based on radiated testing when the testing is performed in an over-the-air (OTA) environment, and wherein the respective method is applicable for NR FR2 device testing (i.e., for mmWave devices). The testing is typically performed in anechoic chambers. For example, FIG. 2 illustrates a test system 200 for radiated testing according to one embodiment. The test system 200 includes test equipment 102 and a DUT 104 (e.g., UE) in an anechoic chamber 202. The test equipment 102 of the test system 200 may include, for example, a BS emulator, propagation channel emulator, and dedicated equipment for performance measurement. As shown in FIG. 2, the test equipment 102 may be connected to measurement and link antennas 204 to propagate an OTA signal 206 to the DUT 104 in the anechoic chamber 202.

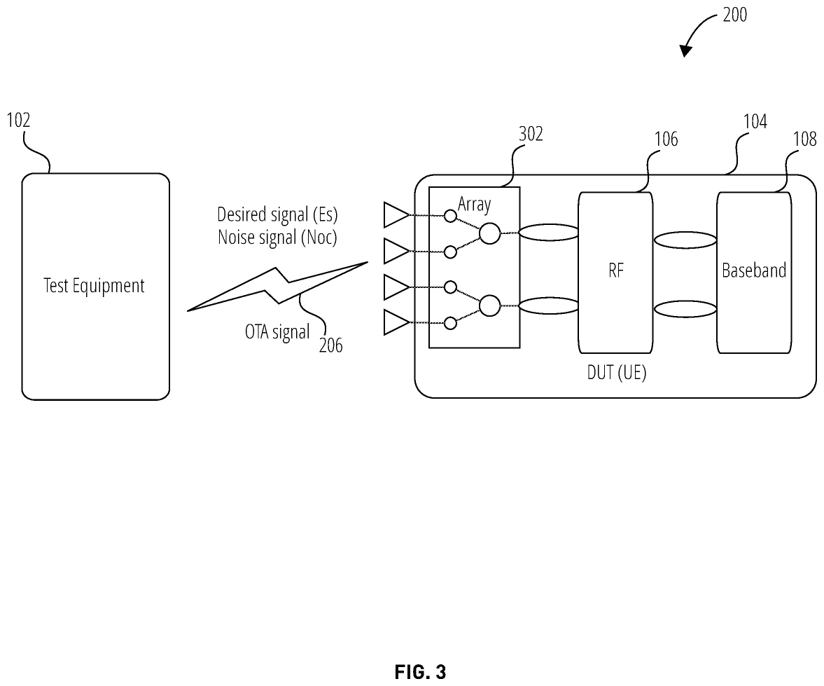

As shown in FIG. 3, the DUT 104 for radiated testing typically represent a whole device implementation which additionally includes an antenna array 302, the RF 106, and the baseband 108 components of the UE.

There are two general approaches or modes for the side conditions emulation for the UE performance requirements definition. Mode 1 is target SNR or signal-to-interference plus noise ratio (SINR) emulation. The test system transmits both a desired signal with power level Es and an artificial AWGN signal with power level Noc in a way to emulate target SNR conditions, where SNR=Es/Noc (in linear scale). Mode 1 is applicable for the general UE Demodulation and CSI performance requirements. The Noc may be selected to ensure that it is far above UE RF noise floor to focus on baseband performance verification. Typically, the SNR and Noc power levels are specified for each test. In such cases, the Es power level can be simply derived based on the SNR and Noc levels (Es=SNR*Noc). Mode 2 is noise free conditions emulation where the test system transmits a desired signal with power level Es without artificial noise. Mode 2 is applicable for the sustained data rate (SDR) requirements and selected UE Demodulation and CSI reporting requirements. Es power may be specified as a per-test parameter. Further, Es power level may be selected in a way to ensure that effective SNR is above a certain threshold.

UE performance requirements may be typically defined with respect to the baseband performance and specify the minimum SNR to be provided for the baseband receiver (Rx) chains. For Mode 1 operation, the test system transmits both a desired signal with power level Es and an artificial AWGN signal with power level Noc in a way to emulate target SNR conditions. The receive signals pass through UE RF chains where additional UE RF noise is injected into the signal. Therefore, an effective SNR observed at the UE baseband side upon propagation through the RF chains is reduced comparing to the input SNR. For Mode 2 operation, the test system transmits a desired signal only and in theory the effective SNR level in this is limited by the accuracy (error vector magnitude) of the desired signal emulation. Similarly, additional UE RF noise is injected in the RF chains and the SNR observed at the UE baseband Rx chains is impacted by the UE RF noise power level.

Embodiments described herein may be directed to several systems, apparatus, techniques, and/or processes to set the Noc, SNR and Es level to minimize the impact of the UE RF noise impact on the baseband SNR during the UE performance testing procedures.

In legacy implementations for LTE and NR FR1 device testing, a single value for Es and single value for Noc are defined to ensure applicability for all existing operating frequency bands (also denoted as simply bands). However, in case of using single defined Es and Noc values for NR FR1 it is challenging to guarantee that the baseband SNR loss is negligible.

In legacy implementations for NR FR2, the Noc power level is defined in an operating frequency band-specific manner (i.e. each operating frequency operating band has its own specific Noc power level) and allows adjustment of the Noc power level for different frequency bands and device types. However, the defined Noc values for FR2 do not differentiate the case of devices with multi-band operation support and cannot guarantee that the baseband SNR loss is negligible for the devices supporting multi-band operation.

Embodiments described herein may include: methods to setup a band specific SNR or Noc value to emulate target SNR (effective, observed at baseband Rx chains) for NR FR1 device testing; methods to setup a band specific Es value to emulate noise free conditions for NR FR1 device testing; and/or methods to setup a Noc power level for testing NR FR2 devices with multi-band operation support. Embodiments described herein may provide an adaptive approach to setup SNR, Noc and Es values which will be applicable for testing requirements in all operating bands and minimize the impact on the effective baseband SNR due to UE RF noise.

I(A). SNR Emulation for NR FR1 Device Testing

The UE performance requirements are typically defined with respect to the UE baseband performance and specify the minimum SNR to be provided for the baseband Rx chains. In certain embodiments a test system transmits both a desired signal with power level Es and an artificial AWGN signal with power level Noc in a way to emulate target SNR conditions. The SNR emulated by the test system can be calculated as SNR=Es/Noc, where Es is the useful signal power level (W/Hz), and Noc is an artificial noise power level (W/Hz). Note that the values are in linear scale.

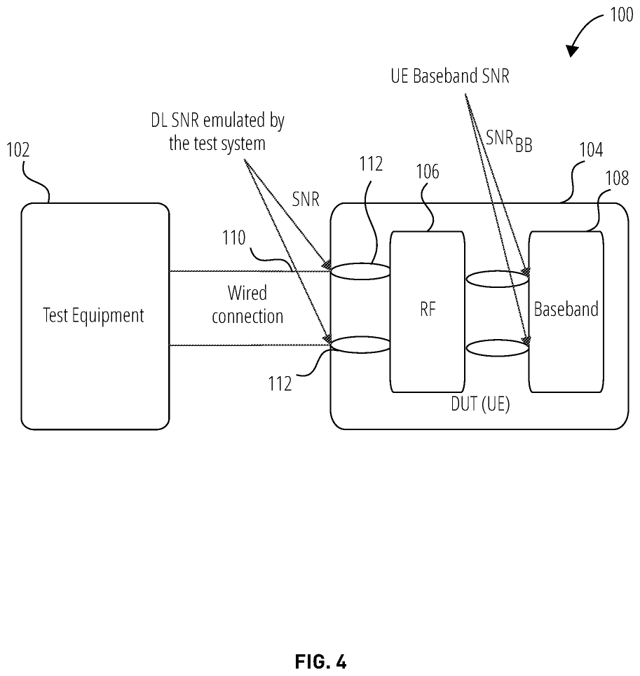

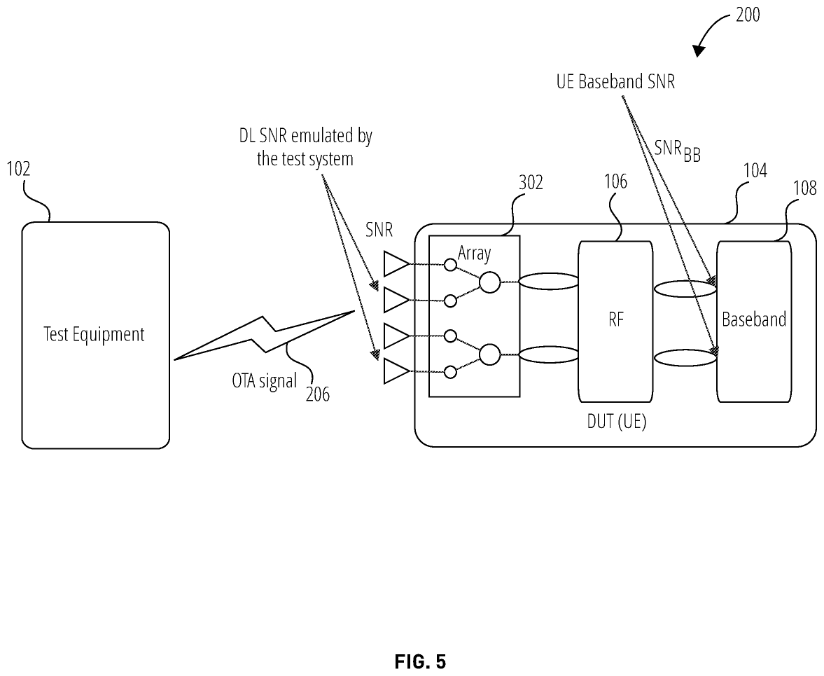

FIG. 4 illustrates the DL SNR emulated by the test system 100 shown in FIG. 1 at the inputs of the antenna connectors 112 for conducted testing as compared to the UE baseband SNR (SNR_{BB}) at the input of the baseband 108. Similarly, FIG. 5 shows the DL SNR emulated by the test system 200 shown in FIG. 3 at the inputs of the antenna array 302 for radiated testing as compared to the SNR_{BB} at the input of the baseband 108. The SNR observed at the Rx baseband can be expressed as SNR_{BB}=Es/(Noc+P_{NoiseRF})=SNR/(1+P_{noiseRF}/Noc)=SNR/(1+A), where P_{NoiseRF} is a UE RF noise power level (W/Hz), and A=P_{noiseRF}/Noc. Note that the values are in linear scale.

The baseband SNR degradation can be expressed as follows. In linear scale: ΔSNR=SNR/SNR_{BB}=(1+A). In dB scale: ΔSNR (dB)=10*log 10 (1+A). As persons skilled in the art will recognize from the disclosure herein, “log 10” or simply “log” refers to log base ten.

Therefore, it may be observed that the difference between the Noc level and the actual UE RF noise floor will have impact on the effective SNR observed in the baseband. For example, assume that artificial noise has a B dB gain over UE RF noise power level: Noc (dBm/Hz)=P_{noiseRF} (dBm/Hz)+B (dB) (in dB scale).

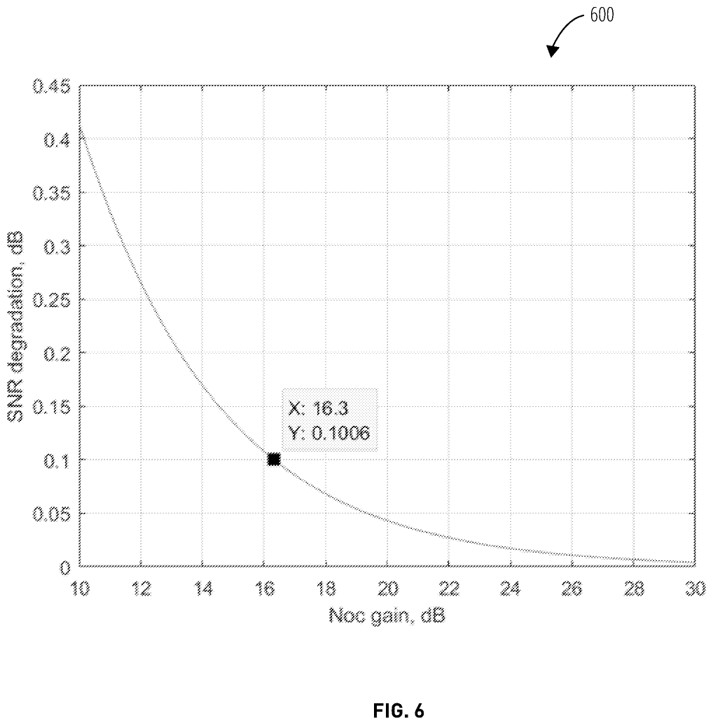

The baseband SNR degradation as a function of the difference between the Noc level and UE RF noise levels (B) is illustrated in FIG. 6. The graph 600 in FIG. 6 shows the SNR loss vs B value (Noc gain over UE RF noise level). From FIG. 6, it may be observed that the effective SNR depends on a relative power difference between the Noc level and UE RF noise. The UE RF noise depends on multiple factors including the frequency band. The UE demodulation and CSI requirements are commonly defined in a band agnostic manner. Whereas, the effective UE RF noise floor may be different for different frequency bands. Therefore, the UR RF noise level should be taken into account when defining SNR, Noc and Es values.

The UE RF noise power level can be derived based on the REFSENS requirements defined in 3GPP TS 38.101-1. In certain embodiments herein, the REFSENS power level can be defined as follows: REFSENS (dBm/Hz)=−174 dBm+10*log 10(BW)+NF−D+SNR_{REFSENS}+IM, where REFSENS is the reference sensitivity requirement defined in TS 38.101-1, NF is the UE noise figure (dB), BW is the receive bandwidth (BW) (Hz), D is the diversity gain (e.g., 3 dB for two Rx antenna) (dB), SNR_{REFSENS} is the SNR used to define the REFSENS requirements (SNR=−1 dB) (dB), and IM is an implementation margin (dB). Note that the values are in dB scale.

The RF noise power level component can be derived as follows: P_{NoiseRF} (dBm/Hz)=−174 dBm+NF+IM=REFSENS−10*log 10(BW)+D−SNR. Based on TS 38.101-1 for NR, for example, the RF noise is in the range from −165 dBm/Hz to −153 dBm/Hz depending on a frequency band.

Embodiments may include, but are not limited to, the following options to setup Noc and SNR for NR FR1 requirements. In a first option: use a fixed value for Noc (e.g., same or different values for different frequency bands); and compensate the SNR degradation during the SNR setup (i.e., the SNR emulated by the test equipment (TE) is adjusted accordingly) by SNR_{New}(dB)=SNR(dB)+ΔSNR(dB), where ΔSNR is defined above and can be derived for each frequency band based on calculated P_{NoiseRF}.

In a second option: Use a per-band variable Noc level in a way to ensure a fixed SNR degradation between the emulated SNR and SNR observed in the baseband Rx chains using Noc (dBm/Hz)=P_{NoiseRF} (dBm/Hz)+X (in dB scale), where X (also referred to as X factor) is a parameter used to adjust the Noc power level (e.g. 15-16 dB to achieve ˜0.1 dB SNR degradation), and P_{NoiseRF} is the RF noise power level derived above for each frequency band.

By way of example using the embodiments described above for SNR emulation for NR FR1 requirements, in TS 38.101-1 the minimum Noc power level for an operating band, subcarrier spacing and channel bandwidth is derived based on the following equation: Noc_{Band_X, SCS_Y, CBW_Z}=REFSENS_{Band_X,_SCS_Y,_CBW_Z}−10*log 10(12*SCS_Y*nPRB)+D−SNR_{REFSENS}+Δₜₕₑᵣₘₐₗ, where REFSENS_{Band_X, SCS_Y, CBW_Z} is the REFSENS value in dBm for Band X, SCS Y and CBW Z specified in Table 7.3.2-1 of TS 38.101-1, 12 is the number of subcarriers in a physical resource block (PRB), SCS Y is the subcarrier spacing associated with the REFSENS value, nPRB is the maximum number of PRB for SCS Y and CBW Z associated with the REFSENS value and is specified in Table 5.3.2-1 of TS 38.101-1, D is diversity gain equal to 3 dB, SNR_{REFSENS}=−1 dB is the SNR used for simulation of REFSENS, and Δₜₕₑᵣₘₐₗ is the amount of dB that the wanted noise is set above UE thermal noise, giving a defined rise in total noise. For example, Δₜₕₑᵣₘₐₗ=16 dB gives a rise in total noise of 0.1 dB, regarded as insignificant. In this example the Δₜₕₑᵣₘₐₗ corresponds to the X factor discussed above.

I(B). Noise Free Condition Emulation for NR FR1 Device Testing

In certain embodiments, for the case of noise free conditions emulation (i.e. the case when artificial noise signal is not transmitted by the test system), the desired signal power level Es may be selected in a way to ensure that effective SNR observed at the UE baseband Rx chains is high enough. For the sustained data rate (SDR) tests, for example, it is desirable to achieve as high as possible SNR level. The following factors may affect the SNR in case the artificial noise signal is not transmitted: test system Tx error vector magnitude (EVM) can be assumed in range of 1.75% to 2% based on LTE 1024QAM WI typical assumptions, which would give about 34 dB to about 36 dB SNR; and/or for the UE RF noise floor, the Es power level may be selected to be high above UE RF noise floor to avoid impacts on SNR (e.g., it is suggested to select the Es in a way to achieve about 35 dB SNR).

Similar to the embodiment above for SNR emulation for FR1 requirements, the UE RF noise may have an impact on the effective SNR. To allow emulation of noise free conditions, embodiments herein may be directed to use a per-band variable Es level in a way to ensure that effective SNR_{bound} (e.g., about 30 dB to about 35 dB) can be reached for all selected operation bands: Es=P_{NoiseRF} (dBm/Hz)+SNR_{bound} dB.

By way of example using the embodiments described herein, in TS 38.101-1 the minimum Es power level for an operating band, subcarrier spacing and channel bandwidth is derived based on the following equation: Es_{Band_X, SCS_Y, CBW_Z}=REFSENS_{Band_X, SCS_Y, CBW_Z}−10*log 10(12*SCS_Y*nPRB)+D−SNR_{REFSENS}+dB_{EVM}+Δₜₕₑᵣₘₐₗ, where REFSENS_{Band_X, SCS_Y, CBW_Z} is the REFSENS value in dBm for Band X, SCS Y and CBW Z specified in Table 7.3.2-1 of TS 38.101-1, 12 is the number of subcarriers in a PRB, SCS Y is the subcarrier spacing associated with the REFSENS value, nPRB is the maximum number of PRB for SCS Y and CBW Z associated with the REFSENS value and is specified in Table 5.3.2-1 of TS 38.101-1, D is diversity gain equal to 3 dB, SNR_{REFSENS}=−1 dB is the SNR used for simulation of REFSENS, dB_{EVM} is the SNR of the applied signal due to EVM impairment on the wanted Es (e.g., an allowed EVM of 3% gives a dB_{EVM} of 30.5 dB, derived as 20*log 10(1/0.03)), and Δₜₕₑᵣₘₐₗ is the amount of dB that the impairment due to EVM on the wanted Es is set above UE thermal noise, giving a defined rise in total impairment. For example, Δₜₕₑᵣₘₐₗ=7.6 dB gives a rise in total impairment of 0.7 dB, regarded as acceptable. The calculated Es value for the baseline of Band n12, 15 kHz SCS, 15 MHz CBW is −113.5 dBm/Hz.

I(C). Setup of Noc Power Level for Testing NR FR2 Devices with Multi-Band Operation Support

Certain embodiments herein provide for selection of Noc for radiated testing of NR FR2 devices with multi-band support (i.e. support of operation in multiple different frequency bands using a single antenna array). For radiated testing of demodulation and CSI requirements it may not be feasible in practice to use signal levels high enough to make the noise contribution of the UE negligible. Demodulation requirements are therefore specified with the applied noise higher than the UE peak EIS level in TS 38.101-2 by a defined amount, so that the impact of UE RF noise floor is limited to no greater than a value Δ_{BB} at the specified Noc level. As UEs have EIS levels that are dependent on operating band and power class, Noc level may be dependent on operating band and power class. The power classes for FR2 UEs are defined in TS 38.101-2 and characterizes UE characteristics in terms of RF and antenna array implementation and may include such factors number of antenna arrays panels, geometry and number of elements in antenna arrays, antenna element gains, UE RF noise figure, RF and antenna implementation losses, and other factors. In particular, different UE power classes may have different REFSENS (reference sensitivity) or EIS (effective isotropic sensitivity) performance.

In certain embodiments, values for Noc according to operating band and power class for single carrier requirements are specified in Table 1 for Δ_{BB}=1 dB, as defined in TS 38.101-4 Table 4.5.3.2-1.

TABLE 1
Noc power level for different UE power
classes and frequency bands

| Operating | UE Power class | | | |
|---|---|---|---|---|
| band | I | 2 | 3 | 4 |
| n257 | −166.8 | −163.8 | −157.6 | −166.3 |
| n258 | −166.8 | −163.8 | −157.6 | −166.3 |
| n260 | −163.8 | | −155.0 | −164.3 |
| n261 | −166.8 | −163.8 | −157.6 | −166.3 |

Note 1: Noc levels are specified in dBm/Hz

The Noc values in Table 1 are based on Refsens for the operating band and on the UE Power class, and taking a baseline of UE Power class 3 in Band n260. Spectral density of Noc=Refsens_{PC3, n260, 50 MHz}−10 Log 10(SCS_{Refsens}×PRB_{Refsens}×12)−SNR_{Refsens}+Δₜₕₑᵣₘₐₗ, where Refsens_{PC3, n260, 50 MHz} is the Refsens value in dBm specified for Power Class 3 in Band n260 for 50 MHz Channel bandwidth in TS 38.101-2, SCS_{Refsens} is a subcarrier spacing associated with N_{RB} for 50 MHz in TS 38.101-2 (Table 5.3.2-1), chosen as 120 kHz, PRB_{SRefsens} is N_{RB} associated with subcarrier spacing 120 kHz for 50 MHz in TS 38.101-2 (Table 5.3.2-1) and is 32, 12 is the number of subcarriers in a PRB, SNR_{Refsens} is the SNR used for simulation of Refsens, and is −1 dB, and Δₜₕₑᵣₘₐₗ is the amount of dB that the wanted noise is set above UE thermal noise, giving a rise in total noise of Δ_{BB}. Δₜₕₑᵣₘₐₗ is chosen as 6 dB, giving a rise in total noise of 1 dB. The calculated Noc value for the baseline of UE Power class 3 in Band n260 in Group Y is rounded to −155 dBm/Hz.

The following methodology to define the Noc level for operating band X (Band_X) and power class Y (PC_Y) may be used for the single carrier case: Noc(Band_X, PC_Y)=−155 dBm/Hz+Refsens_{PC_Y, Band_X, 50 MHz}−Refsens_{PC3, n260, 50 MHz}.

While the existing values are valid for the case of single carrier operation and single band devices, legacy systems have not provided for the handling of Carrier Aggregation or the handling of multi-band relaxation.

FR2 UEs may optionally support operation in multiple FR2 bands (i.e., the same antenna array is designed to support multi-band operation). In order to account for the difference in the antenna design the EIS (Effective Isotropic Sensitivity) requirements for such devices are relaxed.

For FR2 power class 3 UEs, the minimum requirement for reference sensitivity (EIS) requirements may be relaxed per band, respectively, by the reference sensitivity relaxation parameter ΔMB_{P,n} as shown in Table 2, (as defined in Table 6.2.1.3-4 in TS 38.101-2).

TABLE 2
UE multi-band relaxation factors for power class 3 UE

| Supported bands | ΣMB_{P} (dB) | ΣMB_{S} (dB) |
|---|---|---|
| n257, n258 | ≤1.3 | ≤1.25 |
| n258, n260 | ≤1.0 | ≤0.75³ |
| n258, n261 | ≤1.0 | ≤1.25 |
| n260, n261 | 0.0 | ≤0.75² |
| n257, n258, n261 | ≤1.7 | ≤1.75 |
| n257, n260, n261 | ≤0.5 | ≤1.25³ |
| n258, n260, n261 | ≤1.5 | ≤1.25³ |
| n257, n258, n260, n261 | ≤1.7 | ≤1.75³ |

NOTE 1:
The requirements in this table are applicable to UEs which support only the indicated bands
NOTE 2:
For supported bands n260 + n261, ΔMB_{S, n} is not applied for band n260
NOTE 3:
For n260, maximum applicable ΔMB_{S, n} is 0.4 dB

Regarding the reference sensitivity power level for power class 3, the throughput may be ≥95% of the maximum throughput of the reference measurement channels with peak reference sensitivity specified in Table 3 (as defined in Table 7.3.2.3-1 in TS 38.101-2). The requirement may be verified with the test metric of EIS (Link=Beam peak search grids, Meas=Link Angle).

TABLE 3
Reference sensitivity for power class 3 UE

| | REFSENS (dBm)/Channel bandwidth | | | |
|---|---|---|---|---|
| Operating band | 50 MHz | 100 MHz | 200 MHz | 400 MHz |
| n257 | −88.3 | −85.3 | −82.3 | −79.3 |
| n258 | −88.3 | −85.3 | −82.3 | −79.3 |
| n260 | −85.7 | −82.7 | −79.7 | −76.7 |
| n261 | −88.3 | −85.3 | −82.3 | −79.3 |

NOTE 1:
The transmitter shall be set to P_{UMAX} as defined in subclause 6.2.4

For the UEs that support operation in multiple FR2 frequency bands, the minimum requirement for reference sensitivity in Table 3 may be increased per band, respectively, by the reference sensitivity relaxation parameter ΔMB_{P,n} as specified in section 6.2.1.3 of TS 38.101-2.

In certain embodiments herein, the FR2 Noc power level may be adjusted to take into account the relaxations. Certain such embodiments adjust the Noc power level using similar relaxation factor as the one used for RF EIS requirements.

For the UEs that support operation in multiple FR2 bands, the Noc is adjusted as follows: Noc_{MultiBand}=Noc_{SingleBand}+A, where Noc_{SingleBand} (also referred to as Noc_{SB}) is the Noc defined for devices with single band support, Noc_{MultiBand} (also referred to as Noc_{MB}) is the Noc defined for devices with multi band support, and A is the multi-band relaxation parameter.

In one embodiment A=ΣMB_{P}, where ΣMB_{P} defined in TS 38.101-2 in section 6.2.1.3 (i.e., total peak effective isotropic radiated power (EIRP) relaxation). Thus, Noc_{MB}=Noc_{SB}+ΣMB_{P}.

In another embodiment, A=max(ΣMB_{P}, ΣMBₛ), where ΣMBₛ defined in TS 38.101-2 in section 6.2.1.3 (i.e., total EIRP spherical coverage relaxation). Different values can be applied for different frequency band and UE power classes.

In one example embodiment, Noc(Band_X, PC_Y)=−155 dBm/Hz+Refsens_{PC_Y, Band_X, 50 MHz}−Refsens_{PC3, n260, 50 MHz}+ΣMB_{P}.

In another example embodiment, the multi-band Noc can be defined as Noc(Band_X, PC_Y)=Refsens_{Band_X, PC_Y, 50 MHz}−10 Log 10(SCS_{Refsens}×PRB_{Refsens}×12)−SNR_{Refsens}+Δₜₕₑᵣₘₐₗ+ΣMB_{P}.

In another example embodiment the multi-band Noc can be defined as Noc(Band_X, PC_Y)=−155 dBm/Hz+Refsens_{PC_Y, Band_X, 50 MHz}−Refsens_{PC3, n260, 50 MHz}+max(ΣMB_{P}, ΣMBₛ).

In another example embodiment the multi-band Noc can be defined as Noc(Band_X, PC_Y)=Refsens_{Band_X, PC_Y, 50 MHz}−10 Log 10(SCS_{Refsens}×PRB_{Refsens}×12)−SNR_{Refsens}+Δₜₕₑᵣₘₐₗ+max(ΣMB_{P}, ΣMBₛ).

Certain embodiments described herein can be applied to additional frequency ranges. Further, certain embodiments can be applied to other RAT testing (e.g., LTE). In addition, certain embodiments can be applied for either conducted or radiated methods of device testing. Certain embodiment can be also applied for testing RRM (radio resource management) performance of UEs. The embodiments can be also applied for testing other wireless nodes.

### II. DL SNR CONTROL FOR NR MMWAVE OTA UE DEMODULATION AND CSI REPORTING PERFORMANCE REQUIREMENTS TEST METHODOLOGY

Efforts to develop NR technology include developing a test methodology for UE Demodulation and CSI reporting performance requirements for the UE operating in mmWave frequency bands. For instance, efforts may include enabling NR conformance tests for FR2 (frequency range 2), which spans the carrier frequencies from 24.25 GHz to 52.60 GHz. In addition, the test methods can be further extended for other carrier frequencies.

High-frequency devices (e.g., devices operating above 7 GHz) are characterized by a greater level of integration than the one seen today with LTE devices. Such highly integrated architectures may feature innovative front-end solutions, multi-element antenna arrays, passive and active feeding networks, etc. that may not allow for the same testing techniques used to verify RF requirements in devices today.

In LTE and NR FR1 (frequency range 1), the UE conformance testing and verification is usually done using conducted methods when test equipment (measurement system) is directly connected with a device under test (DUT) using a wired connection. Unless otherwise indicated below, device under test (DUT) refers to UE nodes. The connection may generally be done with the chipset/device RF inputs and, hence, the conformance tests and performance requirements do not include the actual antenna implementation at the device side. For mmWave operation a potential highly integrated NR device may not be able to physically expose a front-end cable connector to the test equipment. That is, the interface between the front-end and the antenna may be an antenna array feeding network and the interface may be very tightly integrated, which may preclude the possibility of exposing a test connector. Therefore, radiated OTA (over-the-air) testing is considered as the baseline approach for NR including the UE Demodulation and CSI testing methodology. The following test setup was agreed to be used for UE Demodulation and CSI testing in NR.

II(A). Measurement Setup Examples

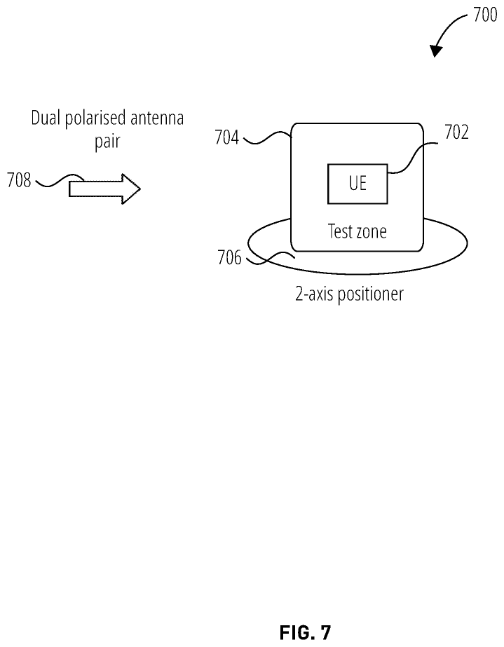

Measurement setup examples described in this section are related to test methods described in TR 38.810. For example, FIG. 7 illustrates an example baseline measurement setup 700 for testing a UE 702. The baseline measurement setup 700 includes placing the 102 within a test zone 704 on a 2-axis positioner 706, and applying a wireless signal 708 from a dual polarized antenna pair (not shown). The baseline measurement setup 700 of NR UE demodulation and CSI characteristics for frequency bands above 6 GHz is capable of establishing an OTA link between the DUT (i.e., the UE 702) and a number of emulated gNB sources with one angle of arrival (AoA) to the UE 702.

Certain aspects of the baseline measurement setup 700 include: the test may be conducted in an anechoic chamber wherein the test may be performed in the radiative near field or in the far field, and/or the minimum measurement distance may be predefined; and one transmission reception point (TRxP) with a dual-polarized measurement antenna may be directed at the DUT. Propagation conditions may provide that the test method allows modelling of the following propagation conditions between the DUT and the emulated gNB sources: multi-path fading propagation conditions, including multi-path fading propagation conditions between the DUT and the emulated gNB sources may be modeled as a Tapped Delay Line (TDL); and static propagation conditions may also be used.

The 2-axis positioner 706 may comprise a positioning system such that the angle between the dual-polarized measurement antenna and the DUT has at least two axes of freedom.

Together with the DUT, the baseline measurement setup 700 provides a capability to achieve a specific isolation between two nominally orthogonal paths from the dual-polarized TRxP to the UE 702, enabling Rank 2 transmission. The capability may use per-port power reporting from the UE 702. Once established, the setup is expected to be fixed and to be used with UE beamlock to allow testing of DUT baseband features under a “virtually cabled” scenario. The capabilities may include selecting the best UE beam during initial call setup.

For setups intended for measurements of UE demodulation and CSI characteristics in non-standalone (NSA) mode with 1UL configuration, an LTE link antenna may be used to provide the LTE link to the DUT. The LTE link antenna provides a stable LTE signal without precise path loss or polarization control.

Applicability criteria may include that the system applies at least to DUTs with a radiating aperture of D≤15 cm. In some embodiments, a manufacturer declaration on the following elements may be used: manufacturer declares antenna arrays size; and if multiple antenna panels that are phase coherent are defined as a single array, the criterion on DUT radiating aperture applies to this single array.

For frequency bands above 6 GHz (e.g. mmWave), conducted antenna connectors are assumed not to be available at the DUT and the OTA testing is considered as the baseline approach for NR UE demodulation and CSI test methodology.

For the UE demodulation testing the test equipment (TE) is expected to emulate receive signals at the UE side with certain target DL SNR. The TE makes transmission of a mixture of the desired (useful) and AWGN (artificial white Gaussian noise) noise signals with certain power levels in a way to achieve certain SNR.

In certain implementations, the test equipment may be able to control the SNR at a reference point (further denoted as SNR_{RP}), which is defined as the intersection of the axes of rotation of the positioning system(s) for the near field (NF) setup and as the geometrical center of the quiet zone (QZ) for the direct far field (DFF) setup. The SNR reference point may be related to the following: for Near-Field setup, the reference point for SNR is defined as the intersection of the axes of rotation of the positioning system(s); and for Far-Field (Direct or Indirect) setup, the reference point for SNR is defined as the geometrical center of the QZ.

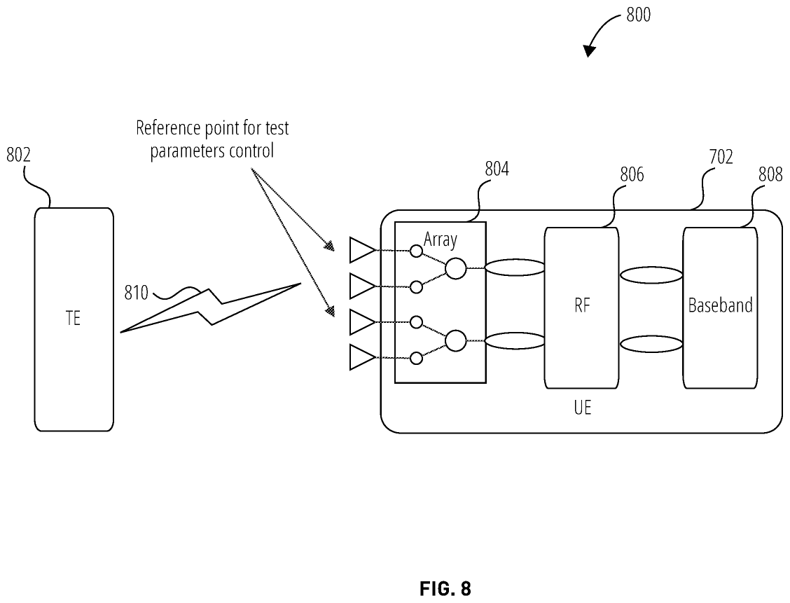

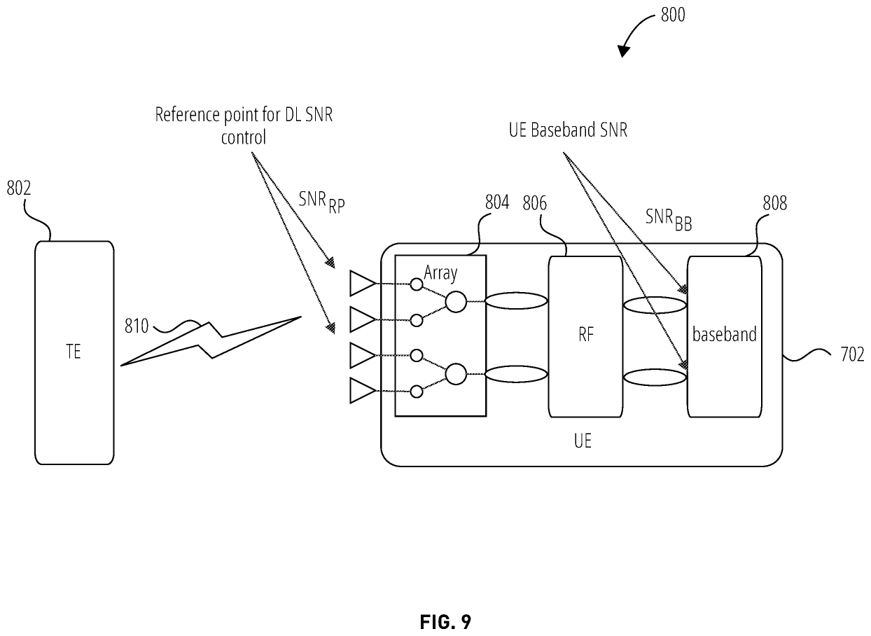

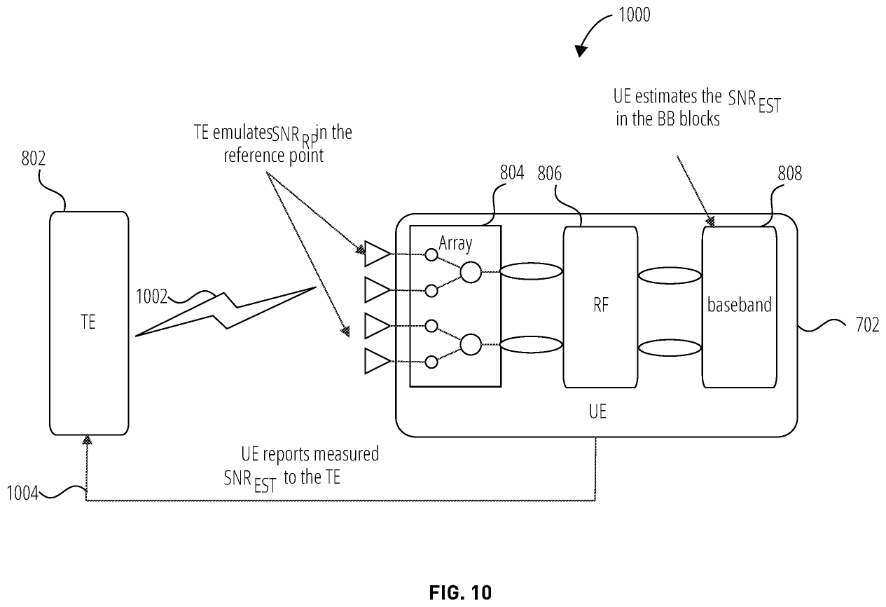

FIG. 8 illustrates a DL SNR reference point for an example test setup 800 according to certain embodiments. In this example, the example test setup 800 includes a UE 702 receiving a wireless DL signal 810 from a TE 802. The UE 702 includes a receiver (Rx) comprising an antenna array 804, RF components of the Rx chain (RF 806), and baseband components of the Rx chain (baseband 808).

Certain test parameters may be controlled by measurement equipment for UE Demodulation and CSI reporting testing, including the SNR of the DL signal 810 at a reference point and faded DL channel. For a Near-Field setup, the reference point for SNR of the DL signal 810 may be defined as the intersection of the axes of rotation of the positioning system(s). For a Far-Field (DFF or IFF) setup the reference point for SNR of the DL signal 810 may defined as the geometrical center of the QZ. As shown in FIG. 8, from the perspective of the UE 702 the reference point is the input of UE's antenna array 804.

However, as shown in FIG. 9, the emulated SNR at the reference point at the input of the antenna array 804 (shown as SNR_{RP}) can be different from the SNR observed at the at UE chipset baseband input (shown as SNR_{BB}). A reason for the mismatch between SNR_{RP} and SNR_{BB} is that the test system may not be capable to generate the signals with very high power and the UE's RF imperfections (e.g., noise floor) will additionally contribute as one of the noise sources.

The problem and initial analysis on the SNR mismatch is described in TR 38.810 v 2.2.0, Section B.3.1 Assessment of testable SNR range. To handle the SNR mismatch, it may be useful to consider: how to calculate the SNR at the reference point for a wanted SNR at the BB of the UE 702 (RAN4 defines a methodology how to calculate the SNR set by the TE 802 at the reference point for a wanted BB SNR); and how to capture the methodology and corresponding SNR value.

Therefore, a defined method to take into account the mismatch between the SNR_{RP} and SNR_{BB} would be useful. Embodiments herein provide several mechanisms to setup the SNR levels for NR FR2 OTA UE demodulation testing.

By default the TE 802 can generate the transmitter (Tx) signals under assumption that the SNR at the reference point and SNR observed at the UE baseband 808 are the same. If the TE 802 generates the Tx signals under assumption that the SNR at the reference point (SNR_{RP}) and SNR observed at the UE baseband 808 (SNR_{BB}) are the same there will be a certain mismatch between these SNR values. In particular, SNR_{BB} will be lower than the SNR_{RP} and there is a high risk that the DUT will fail the test due to methodological issues rather than due to improper UE implementation.

Certain embodiments herein a methodology to set the DL SNR during the NR FR2 UE Demodulation and CSI reporting testing. In a one embodiment, the TE 802 derives the SNR_{RP} from SNR_{BB} based on the equations described infra for the given test and UE parameters. Such embodiments provide a relatively simple methodology to recalculate the SNR values. In another embodiment, the TE 802 derives the SNR_{RP} from SNR_{BB} based on the look-up-table for the given test and UE parameters. In yet another embodiment, the TE 802 performs specific calibration procedure involving SNR estimation at the UE 702 side, and the UE 702 reports back to the TE 802 in order to derive the mapping between the SNR_{RP} and SNR_{BB}. Such embodiments provide an improved method based on the UE measurements/reporting, which potentially allows better SNR control accuracy to improve the reliability of the test procedure.

The embodiments herein provide a clear methodology to derive the SNR for the UE performance testing. The standardized methodology may ensure that all UE conformance testing is done under similar assumptions and provides a unified methodology to be applied in different test labs. The embodiments may also ensure that the SNR is selected with respect to the measurement setup and UE characteristics to avoid the effects due to UE noise floor impact on the tested baseband performance.

In certain embodiments, the following framework can be used for various procedures for the DL SNR control for the NR FR2 test methodologies: UE Demodulation and CSI reporting performance requirements are defined for an SNR point (SNR_{REQ}) that corresponds to the UE baseband SNR (SNR_{BB}); during testing the TE shall generate the signals with SNR_{RP} in the reference point; and the level SNR_{RP} is derived in a way to ensure that SNR_{BB}≥SNR_{REQ}. In a general case, the TE may strive to achieve SNR_{BB}=SNR_{REQ}.

The following procedures may be used to derive the SNR_{RP} value.

II(B). Recalculate the SNR_{RP} Using a Pre-Defined Equation

According to certain embodiments, the SNR_{RP} can be recalculated using a pre-defined equation: SNR_{RP}=F(SNR_{REQ}, A_{UE}, A_{TE}), where F( ) is a function for an SNR_{REQ} value, A_{UE} are UE implementation characteristics, and A_{TE} are measurement setup characteristics.

In one embodiment, SNR_{RP}=SNR_{REQ} (1+A)/(1−A*SNR_{REQ}) and A=N_{ktb}*A_{UE}/A_{TE}, where SNR_{RP} is the reference point SNR, SNR_{REQ} is the target requirement SNR at the UE baseband, and N_{ktb} is the thermal noise level. A_{UE} is the factor characterizing UE implementation including antenna gains, implementations loss, and noise floor. For example, A_{UE}=F_{UE}/(G_{UE}*IL_{UE}), wherein F_{UE} is the Noise figure (NF) of the UE, G_{UE} is the UE receive antenna array gain, and IL_{UE} is the UE receiver implementation loss. A_{TE} is the factor characterizing TE/measurement system characteristics including propagation loss between the TE probe and reference point, and TE probe transmit power. For example, A_{TE}=(P_{TX_MAX}*PL), wherein P_{TX_MAX} is the TE probe max Tx power (per Hz), and PL is the pathloss between the TE and DUT (e.g. free space loss). Note that in the above, the symbols are represented as linear (non-dB) values.

In another embodiment, SNR_{RP}=SNR_{REQ}/(1−A*SNR_{REQ}) and A=N_{ktb}*A_{UE}/A_{TE}, where SNR_{RP} is the reference point SNR, SNR_{REQ} is the target requirement SNR at the UE baseband, and N_{ktb} is the thermal noise level. A_{UE} is the factor characterizing UE implementation including antenna gains, implementations loss, noise floor. For example, A_{UE}=F_{UE}/(G_{UE}*IL_{UE}), wherein F_{UE} is the Noise figure (NF) of the UE, G_{UE} is the UE receive antenna array gain, and IL_{UE} is the UE receiver implementation loss. A_{TE} is the factor characterizing TE/measurement system characteristics including propagation loss between the TE probe and reference point, and TE probe transmit power. For example, A_{TE}=(S_{TX}*PL), wherein S_{TX} is the TE probe desired signal Tx power (per Hz), and PL is the pathloss between the TE and DUT (e.g., free space loss). Note that in the above, the symbols are represented as linear (non-dB) values.

Several procedures for UE parameters setup can be considered. In a first option, the UE parameters (e.g., A_{UE}, F_{UE}, G_{UE}, IL_{UE}) are declared by the UE for the test procedure. In a second option, the test equipment uses pre-defined UE parameters (e.g., worst case) assumptions, which may be provided in the standard specifications. Values can be different for different frequency bands, device types or UE power classes. The measurement setup parameters are expected to be known during the test.

II(C). Derive the SNR_{RP} Using a Look-Up Table

According to another embodiment, the SNR_{RP} can be derived from SNR_{BB} using a look-up table (LUT). The LUT may be defined, for example, in the 3GPP specification. The LUT can be derived based on Method A principles.

II(D). Use an SNR Calibration Procedure to Map Between SNR_{RP} and SNR_{BB}

FIG. 10 illustrates an example test setup 1000 according to another embodiment that feedback 1004 from the UE 702 to the TE 802. According to certain such embodiments, the measurement system can use a specific SNR calibration procedure to derive information on the mapping between the SNR_{RP} and SNR_{BB}. The calibration procedure shown by FIG. 10 may include the following operations: the TE 802 generates the DL signal with certain SNR_{RP} in the reference point at the input to the antenna array 804; the UE 702 performs the measurement of the DL signal SNR (SNR_{EST}); the UE 702 reports SNR_{EST} to the TE 802; and the TE 802 uses the reported SNR_{EST} (e.g. difference between SNR_{RP} and SNR_{EST}) to adjust the SNR_{RP} during the test to ensure that achieve SNR_{BB} is close to the SNR_{REQ}.

With respect to the DL SNR measurement and reporting, the UE 702 may perform existing SNR measurements defined, for example, in TS 38.215 (e.g., SS-SINR, CSI-SINR). Additional metrics can be defined (e.g., SNR or SINR per each receiver port). In the procedure it is assumed that SNR_{EST} is equivalent to SNR_{BB}. The reporting can be done using existing reporting mechanisms for radio resource management (RRM) measurements reporting. The reporting can be done as a part of a test loop mode.

During the calibration procedure, the TE 802 may perform screening for a range SNR_{RP} values in order to obtain information on the SNR_{EST} observed at the UE BB side. The TE 802 can obtain the LUT between the SNR_{RP} and SNR_{EST}.

For the SNR_{RP} setup for the requirements testing the TE 802 can set the SNR_{RP} based on data obtained from calibration procedure (e.g., from UE 702). The TE 802 may also further adjust the SNR_{RP} to account for SNR_{EST} measurement inaccuracy at the UE side.

Additionally, a similar procedure can be used for any OTA testing methodology including the RF and RRM (radio resource management) testing. The various embodiments discussed above can be applied for NR FR1 and LTE OTA testing. Moreover, a combination of disclosed embodiments may be applied.

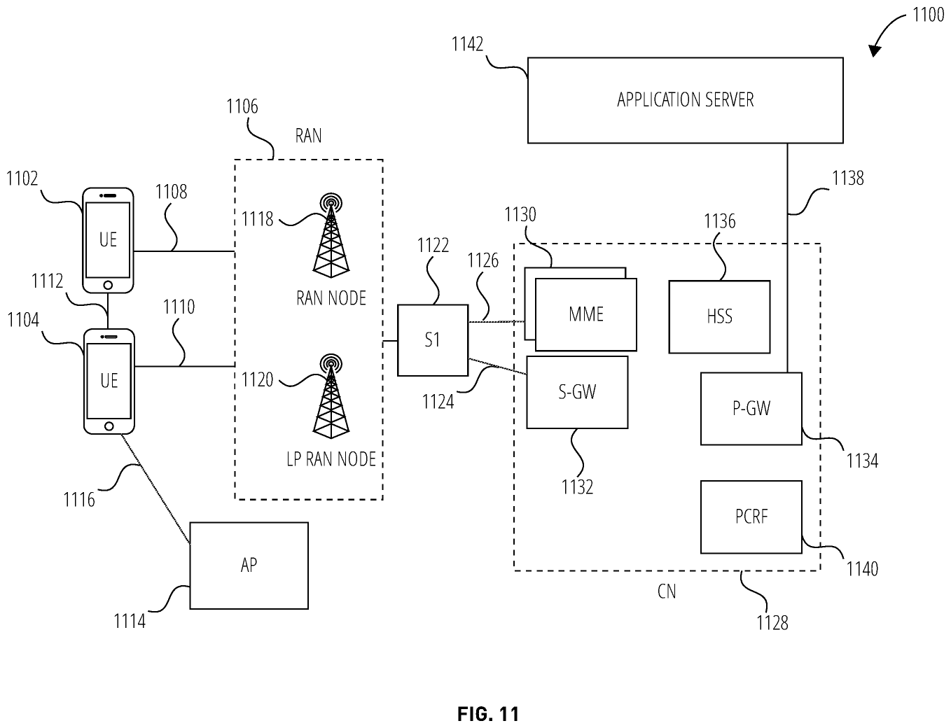

FIG. 11 illustrates an architecture of a system 1100 of a network in accordance with some embodiments. The system 1100 includes one or more user equipment (UE), shown in this example as a UE 1102 and a UE 1104. The UE 1102 and the UE 1104 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UE 1102 and the UE 1104 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UE 1102 and the UE 1104 may be configured to connect, e.g., communicatively couple, with a radio access network (RAN), shown as RAN 1106. The RAN 1106 may be, for example, an Evolved Universal Mobile Telecommunications System (UMTS) Terrestrial Radio Access Network (E-UTRAN), a NextGen RAN (NG RAN), or some other type of RAN. The UE 1102 and the UE 1104 utilize connection 1108 and connection 1110, respectively, each of which comprises a physical communications interface or layer (discussed in further detail below); in this example, the connection 1108 and the connection 1110 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UE 1102 and the UE 1104 may further directly exchange communication data via a ProSe interface 1112. The ProSe interface 1112 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 1104 is shown to be configured to access an access point (AP), shown as AP 1114, via connection 1116. The connection 1116 can comprise a local wireless connection, such as a connection consistent with any IEEE 802.11 protocol, wherein the AP 1114 would comprise a wireless fidelity (WiFi®) router. In this example, the AP 1114 may be connected to the Internet without connecting to the core network of the wireless system (described in further detail below).

The RAN 1106 can include one or more access nodes that enable the connection 1108 and the connection 1110. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The RAN 1106 may include one or more RAN nodes for providing macrocells, e.g., macro RAN node 1118, and one or more RAN nodes for providing femtocells or picocells (e.g., cells having smaller coverage areas, smaller user capacity, or higher bandwidth compared to macrocells), e.g., a low power (LP) RAN node such as LP RAN node 1120.

Any of the macro RAN node 1118 and the LP RAN node 1120 can terminate the air interface protocol and can be the first point of contact for the UE 1102 and the UE 1104. In some embodiments, any of the macro RAN node 1118 and the LP RAN node 1120 can fulfill various logical functions for the RAN 1106 including, but not limited to, radio network controller (RNC) functions such as radio bearer management, uplink and downlink dynamic radio resource management and data packet scheduling, and mobility management.

In accordance with some embodiments, the UE 1102 and the UE 1104 can be configured to communicate using Orthogonal Frequency-Division Multiplexing (OFDM) communication signals with each other or with any of the macro RAN node 1118 and the LP RAN node 1120 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the macro RAN node 1118 and the LP RAN node 1120 to the UE 1102 and the UE 1104, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UE 1102 and the UE 1104. The physical downlink control channel (PDCCH) may carry information about the transport format and resource allocations related to the PDSCH channel, among other things. It may also inform the UE 1102 and the UE 1104 about the transport format, resource allocation, and H-ARQ (Hybrid Automatic Repeat Request) information related to the uplink shared channel. Typically, downlink scheduling (assigning control and shared channel resource blocks to the UE 1104 within a cell) may be performed at any of the macro RAN node 1118 and the LP RAN node 1120 based on channel quality information fed back from any of the UE 1102 and UE 1104. The downlink resource assignment information may be sent on the PDCCH used for (e.g., assigned to) each of the UE 1102 and the UE 1104.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as enhanced resource element groups (EREGs). An ECCE may have other numbers of EREGs in some situations.

The RAN 1106 is communicatively coupled to a core network (CN), shown as CN 1128—via an S1 interface 1122. In embodiments, the CN 1128 may be an evolved packet core (EPC) network, a NextGen Packet Core (NPC) network, or some other type of CN. In this embodiment the S1 interface 1122 is split into two parts: the S1-U interface 1124, which carries traffic data between the macro RAN node 1118 and the LP RAN node 1120 and a serving gateway (S-GW), shown as S-GW 1132, and an S1-mobility management entity (MME) interface, shown as S1-MME interface 1126, which is a signaling interface between the macro RAN node 1118 and LP RAN node 1120 and the MME(s) 1130.

In this embodiment, the CN 1128 comprises the MME(s) 1130, the S-GW 1132, a Packet Data Network (PDN) Gateway (P-GW) (shown as P-GW 1134), and a home subscriber server (HSS) (shown as HSS 1136). The MME(s) 1130 may be similar in function to the control plane of legacy Serving General Packet Radio Service (GPRS) Support Nodes (SGSN). The MME(s) 1130 may manage mobility aspects in access such as gateway selection and tracking area list management. The HSS 1136 may comprise a database for network users, including subscription-related information to support the network entities' handling of communication sessions. The CN 1128 may comprise one or several HSS 1136, depending on the number of mobile subscribers, on the capacity of the equipment, on the organization of the network, etc. For example, the HSS 1136 can provide support for routing/roaming, authentication, authorization, naming/addressing resolution, location dependencies, etc.

The S-GW 1132 may terminate the S1 interface 322 towards the RAN 1106, and routes data packets between the RAN 1106 and the CN 1128. In addition, the S-GW 1132 may be a local mobility anchor point for inter-RAN node handovers and also may provide an anchor for inter-3GPP mobility. Other responsibilities may include lawful intercept, charging, and some policy enforcement.

The P-GW 1134 may terminate an SGi interface toward a PDN. The P-GW 1134 may route data packets between the CN 1128 (e.g., an EPC network) and external networks such as a network including the application server 1142 (alternatively referred to as application function (AF)) via an Internet Protocol (IP) interface (shown as IP communications interface 1138). Generally, an application server 1142 may be an element offering applications that use IP bearer resources with the core network (e.g., UMTS Packet Services (PS) domain, LTE PS data services, etc.). In this embodiment, the P-GW 1134 is shown to be communicatively coupled to an application server 1142 via an IP communications interface 1138. The application server 1142 can also be configured to support one or more communication services (e.g., Voice-over-Internet Protocol (VoIP) sessions, PTT sessions, group communication sessions, social networking services, etc.) for the UE 1102 and the UE 1104 via the CN 1128.

The P-GW 1134 may further be a node for policy enforcement and charging data collection. A Policy and Charging Enforcement Function (PCRF) (shown as PCRF 1140) is the policy and charging control element of the CN 1128. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 1140 may be communicatively coupled to the application server 1142 via the P-GW 1134. The application server 1142 may signal the PCRF 1140 to indicate a new service flow and select the appropriate Quality of Service (QoS) and charging parameters. The PCRF 1140 may provision this rule into a Policy and Charging Enforcement Function (PCEF) (not shown) with the appropriate traffic flow template (TFT) and QoS class of identifier (QCI), which commences the QoS and charging as specified by the application server 1142.

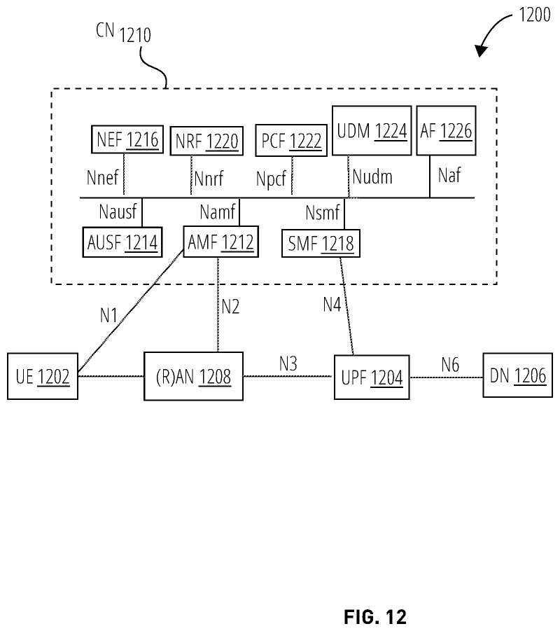

FIG. 12 illustrates an architecture of a system 1200 of a network in accordance with some embodiments. The system 1200 is shown to include a UE 1202, which may be the same or similar to the UE 1102 and the UE 1104 discussed previously; a 5G access node or RAN node (shown as (R)AN node 1208), which may be the same or similar to the macro RAN node 1118 and/or the LP RAN node 1120 discussed previously; a User Plane Function (shown as UPF 1204); a Data Network (DN 1206), which may be, for example, operator services, Internet access or 3rd party services; and a 5G Core Network (5GC) (shown as CN 1210).

The CN 1210 may include an Authentication Server Function (AUSF 1214); a Core Access and Mobility Management Function (AMF 1212); a Session Management Function (SMF 1218); a Network Exposure Function (NEF 1216); a Policy Control Function (PCF 1222); a Network Function (NF) Repository Function (NRF 1220); a Unified Data Management (UDM 1224); and an Application Function (AF 1226). The CN 1210 may also include other elements that are not shown, such as a Structured Data Storage network function (SDSF), an Unstructured Data Storage network function (UDSF), and the like.

The UPF 1204 may act as an anchor point for intra-RAT and inter-RAT mobility, an external PDU session point of interconnect to DN 1206, and a branching point to support multi-homed PDU session. The UPF 1204 may also perform packet routing and forwarding, packet inspection, enforce user plane part of policy rules, lawfully intercept packets (UP collection); traffic usage reporting, perform QoS handling for user plane (e.g. packet filtering, gating, UL/DL rate enforcement), perform Uplink Traffic verification (e.g., SDF to QoS flow mapping), transport level packet marking in the uplink and downlink, and downlink packet buffering and downlink data notification triggering. UPF 1204 may include an uplink classifier to support routing traffic flows to a data network. The DN 1206 may represent various network operator services, Internet access, or third party services. DN 1206 may include, or be similar to the application server 1142 discussed previously.

The AUSF 1214 may store data for authentication of UE 1202 and handle authentication related functionality. The AUSF 1214 may facilitate a common authentication framework for various access types.

The AMF 1212 may be responsible for registration management (e.g., for registering UE 1202, etc.), connection management, reachability management, mobility management, and lawful interception of AMF-related events, and access authentication and authorization. AMF 1212 may provide transport for SM messages for the SMF 1218, and act as a transparent proxy for routing SM messages. AMF 1212 may also provide transport for short message service (SMS) messages between UE 1202 and an SMS function (SMSF) (not shown by FIG. 12). AMF 1212 may act as Security Anchor Function (SEA), which may include interaction with the AUSF 1214 and the UE 1202, receipt of an intermediate key that was established as a result of the UE 1202 authentication process. Where USIM based authentication is used, the AMF 1212 may retrieve the security material from the AUSF 1214. AMF 1212 may also include a Security Context Management (SCM) function, which receives a key from the SEA that it uses to derive access-network specific keys. Furthermore, AMF 1212 may be a termination point of RAN CP interface (N2 reference point), a termination point of NAS (NI) signaling, and perform NAS ciphering and integrity protection.

AMF 1212 may also support NAS signaling with a UE 1202 over an N3 interworking-function (IWF) interface. The N3IWF may be used to provide access to untrusted entities. N3IWF may be a termination point for the N2 and N3 interfaces for control plane and user plane, respectively, and as such, may handle N2 signaling from SMF and AMF for PDU sessions and QoS, encapsulate/de-encapsulate packets for IPSec and N3 tunneling, mark N3 user-plane packets in the uplink, and enforce QoS corresponding to N3 packet marking taking into account QoS requirements associated to such marking received over N2. N3IWF may also relay uplink and downlink control-plane NAS (NI) signaling between the UE 1202 and AMF 1212, and relay uplink and downlink user-plane packets between the UE 1202 and UPF 1204. The N3IWF also provides mechanisms for IPsec tunnel establishment with the UE 1202.

The SMF 1218 may be responsible for session management (e.g., session establishment, modify and release, including tunnel maintain between UPF and AN node); UE IP address allocation & management (including optional Authorization); Selection and control of UP function; Configures traffic steering at UPF to route traffic to proper destination; termination of interfaces towards Policy control functions; control part of policy enforcement and QoS; lawful intercept (for SM events and interface to LI System); termination of SM parts of NAS messages; downlink Data Notification; initiator of AN specific SM information, sent via AMF over N2 to AN; determine SSC mode of a session. The SMF 1218 may include the following roaming functionality: handle local enforcement to apply QoS SLAB (VPLMN); charging data collection and charging interface (VPLMN); lawful intercept (in VPLMN for SM events and interface to LI System); support for interaction with external DN for transport of signaling for PDU session authorization/authentication by external DN.

The NEF 1216 may provide means for securely exposing the services and capabilities provided by 3GPP network functions for third party, internal exposure/re-exposure, Application Functions (e.g., AF 1226), edge computing or fog computing systems, etc. In such embodiments, the NEF 1216 may authenticate, authorize, and/or throttle the AFs. NEF 1216 may also translate information exchanged with the AF 1226 and information exchanged with internal network functions. For example, the NEF 1216 may translate between an AF-Service-Identifier and an internal 5GC information. NEF 1216 may also receive information from other network functions (NFs) based on exposed capabilities of other network functions. This information may be stored at the NEF 1216 as structured data, or at a data storage NF using a standardized interfaces. The stored information can then be re-exposed by the NEF 1216 to other NFs and AFs, and/or used for other purposes such as analytics.

The NRF 1220 may support service discovery functions, receive NF Discovery Requests from NF instances, and provide the information of the discovered NF instances to the NF instances. NRF 1220 also maintains information of available NF instances and their supported services.

The PCF 1222 may provide policy rules to control plane function(s) to enforce them, and may also support unified policy framework to govern network behavior. The PCF 1222 may also implement a front end (FE) to access subscription information relevant for policy decisions in a UDR of UDM 1224.

The UDM 1224 may handle subscription-related information to support the network entities' handling of communication sessions, and may store subscription data of UE 1202. The UDM 1224 may include two parts, an application FE and a User Data Repository (UDR). The UDM may include a UDM FE, which is in charge of processing of credentials, location management, subscription management and so on. Several different front ends may serve the same user in different transactions. The UDM-FE accesses subscription information stored in the UDR and performs authentication credential processing; user identification handling; access authorization; registration/mobility management; and subscription management. The UDR may interact with PCF 1222. UDM 1224 may also support SMS management, wherein an SMS-FE implements the similar application logic as discussed previously.

The AF 1226 may provide application influence on traffic routing, access to the Network Capability Exposure (NCE), and interact with the policy framework for policy control. The NCE may be a mechanism that allows the 5GC and AF 1226 to provide information to each other via NEF 1216, which may be used for edge computing implementations. In such implementations, the network operator and third party services may be hosted close to the UE 1202 access point of attachment to achieve an efficient service delivery through the reduced end-to-end latency and load on the transport network. For edge computing implementations, the 5GC may select a UPF 1204 close to the UE 1202 and execute traffic steering from the UPF 1204 to DN 1206 via the N6 interface. This may be based on the UE subscription data, UE location, and information provided by the AF 1226. In this way, the AF 1226 may influence UPF (re)selection and traffic routing. Based on operator deployment, when AF 1226 is considered to be a trusted entity, the network operator may permit AF 1226 to interact directly with relevant NFs.

As discussed previously, the CN 1210 may include an SMSF, which may be responsible for SMS subscription checking and verification, and relaying SM messages to/from the UE 1202 to/from other entities, such as an SMS-GMSC/IWMSC/SMS-router. The SMS may also interact with AMF 1212 and UDM 1224 for notification procedure that the UE 1202 is available for SMS transfer (e.g., set a UE not reachable flag, and notifying UDM 1224 when UE 1202 is available for SMS).

The system 1200 may include the following service-based interfaces: Namf: Service-based interface exhibited by AMF; Nsmf: Service-based interface exhibited by SMF; Nnef: Service-based interface exhibited by NEF; Npcf: Service-based interface exhibited by PCF; Nudm: Service-based interface exhibited by UDM; Naf: Service-based interface exhibited by AF; Nnrf: Service-based interface exhibited by NRF; and Nausf: Service-based interface exhibited by AUSF.

The system 1200 may include the following reference points: N1: Reference point between the UE and the AMF; N2: Reference point between the (R)AN and the AMF; N3: Reference point between the (R)AN and the UPF; N4: Reference point between the SMF and the UPF; and N6: Reference point between the UPF and a Data Network. There may be many more reference points and/or service-based interfaces between the NF services in the NFs, however, these interfaces and reference points have been omitted for clarity. For example, an NS reference point may be between the PCF and the AF; an N7 reference point may be between the PCF and the SMF; an N11 reference point between the AMF and SMF; etc. In some embodiments, the CN 1210 may include an Nx interface, which is an inter-CN interface between the MME (e.g., MME(s) 1130) and the AMF 1212 in order to enable interworking between CN 1210 and CN 1128.

Although not shown by FIG. 12, the system 1200 may include multiple RAN nodes (such as (R)AN node 1208) wherein an Xn interface is defined between two or more (R)AN node 1208 (e.g., gNBs and the like) that connecting to 5GC 410, between a (R)AN node 1208 (e.g., gNB) connecting to CN 1210 and an eNB (e.g., a macro RAN node 1118 of FIG. 11), and/or between two eNBs connecting to CN 1210.

In some implementations, the Xn interface may include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 1202 in a connected mode (e.g., CM-CONNECTED) including functionality to manage the UE mobility for connected mode between one or more (R)AN node 1208. The mobility support may include context transfer from an old (source) serving (R)AN node 1208 to new (target) serving (R)AN node 1208; and control of user plane tunnels between old (source) serving (R)AN node 1208 to new (target) serving (R)AN node 1208.

A protocol stack of the Xn-U may include a transport network layer built on Internet Protocol (IP) transport layer, and a GTP-U layer on top of a UDP and/or IP layer(s) to carry user plane PDUs. The Xn-C protocol stack may include an application layer signaling protocol (referred to as Xn Application Protocol (Xn-AP)) and a transport network layer that is built on an SCTP layer. The SCTP layer may be on top of an IP layer. The SCTP layer provides the guaranteed delivery of application layer messages. In the transport IP layer point-to-point transmission is used to deliver the signaling PDUs. In other implementations, the Xn-U protocol stack and/or the Xn-C protocol stack may be same or similar to the user plane and/or control plane protocol stack(s) shown and described herein.

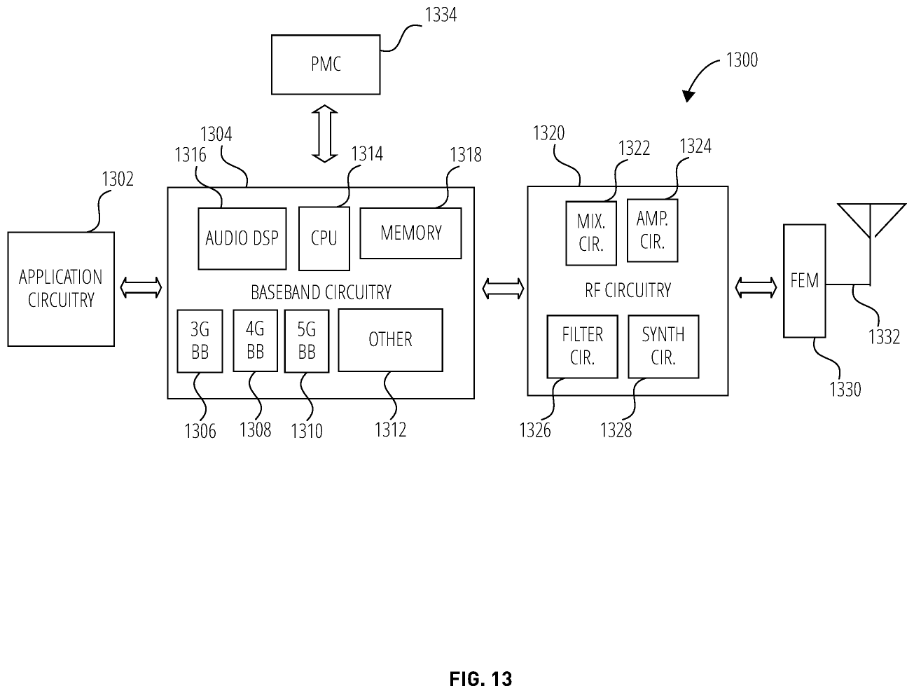

FIG. 13 illustrates example components of a device 1300 in accordance with some embodiments. In some embodiments, the device 1300 may include application circuitry 1302, baseband circuitry 1304, Radio Frequency (RF) circuitry (shown as RF circuitry 1320), front-end module (FEM) circuitry (shown as FEM circuitry 1330), one or more antennas 1332, and power management circuitry (PMC) (shown as PMC 1334) coupled together at least as shown. The components of the illustrated device 1300 may be included in a UE or a RAN node. In some embodiments, the device 1300 may include fewer elements (e.g., a RAN node may not utilize application circuitry 1302, and instead include a processor/controller to process IP data received from an EPC). In some embodiments, the device 1300 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 1302 may include one or more application processors. For example, the application circuitry 1302 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 1300. In some embodiments, processors of application circuitry 1302 may process IP data packets received from an EPC.

The baseband circuitry 1304 may include circuitry such as, but not limited to, one or more single-core or multi-core processors. The baseband circuitry 1304 may include one or more baseband processors or control logic to process baseband signals received from a receive signal path of the RF circuitry 1320 and to generate baseband signals for a transmit signal path of the RF circuitry 1320. The baseband circuitry 1304 may interface with the application circuitry 1302 for generation and processing of the baseband signals and for controlling operations of the RF circuitry 1320. For example, in some embodiments, the baseband circuitry 1304 may include a third generation (3G) baseband processor (3G baseband processor 1306), a fourth generation (4G) baseband processor (4G baseband processor 1308), a fifth generation (5G) baseband processor (5G baseband processor 1310), or other baseband processor(s) 1312 for other existing generations, generations in development or to be developed in the future (e.g., second generation (2G), sixth generation (6G), etc.). The baseband circuitry 1304 (e.g., one or more of baseband processors) may handle various radio control functions that enable communication with one or more radio networks via the RF circuitry 1320. In other embodiments, some or all of the functionality of the illustrated baseband processors may be included in modules stored in the memory 1318 and executed via a Central Processing Unit (CPU 1314). The radio control functions may include, but are not limited to, signal modulation/demodulation, encoding/decoding, radio frequency shifting, etc. In some embodiments, modulation/demodulation circuitry of the baseband circuitry 1304 may include Fast-Fourier Transform (FFT), precoding, or constellation mapping/demapping functionality. In some embodiments, encoding/decoding circuitry of the baseband circuitry 1304 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1304 may include a digital signal processor (DSP), such as one or more audio DSP(s) 1316. The one or more audio DSP(s) 1316 may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 1304 and the application circuitry 1302 may be implemented together such as, for example, on a system on a chip (SOC).

In some embodiments, the baseband circuitry 1304 may provide for communication compatible with one or more radio technologies. For example, in some embodiments, the baseband circuitry 1304 may support communication with an evolved universal terrestrial radio access network (EUTRAN) or other wireless metropolitan area networks (WMAN), a wireless local area network (WLAN), or a wireless personal area network (WPAN). Embodiments in which the baseband circuitry 1304 is configured to support radio communications of more than one wireless protocol may be referred to as multi-mode baseband circuitry.

The RF circuitry 1320 may enable communication with wireless networks using modulated electromagnetic radiation through a non-solid medium. In various embodiments, the RF circuitry 1320 may include switches, filters, amplifiers, etc. to facilitate the communication with the wireless network. The RF circuitry 1320 may include a receive signal path which may include circuitry to down-convert RF signals received from the FEM circuitry 1330 and provide baseband signals to the baseband circuitry 1304. The RF circuitry 1320 may also include a transmit signal path which may include circuitry to up-convert baseband signals provided by the baseband circuitry 1304 and provide RF output signals to the FEM circuitry 1330 for transmission.

In some embodiments, the receive signal path of the RF circuitry 1320 may include mixer circuitry 1322, amplifier circuitry 1324 and filter circuitry 1326. In some embodiments, the transmit signal path of the RF circuitry 1320 may include filter circuitry 1326 and mixer circuitry 1322. The RF circuitry 1320 may also include synthesizer circuitry 1328 for synthesizing a frequency for use by the mixer circuitry 1322 of the receive signal path and the transmit signal path. In some embodiments, the mixer circuitry 1322 of the receive signal path may be configured to down-convert RF signals received from the FEM circuitry 1330 based on the synthesized frequency provided by synthesizer circuitry 1328. The amplifier circuitry 1324 may be configured to amplify the down-converted signals and the filter circuitry 1326 may be a low-pass filter (LPF) or band-pass filter (BPF) configured to remove unwanted signals from the down-converted signals to generate output baseband signals. Output baseband signals may be provided to the baseband circuitry 1304 for further processing. In some embodiments, the output baseband signals may be zero-frequency baseband signals, although this is not a requirement. In some embodiments, the mixer circuitry 1322 of the receive signal path may comprise passive mixers, although the scope of the embodiments is not limited in this respect.

In some embodiments, the mixer circuitry 1322 of the transmit signal path may be configured to up-convert input baseband signals based on the synthesized frequency provided by the synthesizer circuitry 1328 to generate RF output signals for the FEM circuitry 1330. The baseband signals may be provided by the baseband circuitry 1304 and may be filtered by the filter circuitry 1326.

In some embodiments, the mixer circuitry 1322 of the receive signal path and the mixer circuitry 1322 of the transmit signal path may include two or more mixers and may be arranged for quadrature downconversion and upconversion, respectively. In some embodiments, the mixer circuitry 1322 of the receive signal path and the mixer circuitry 1322 of the transmit signal path may include two or more mixers and may be arranged for image rejection (e.g., Hartley image rejection). In some embodiments, the mixer circuitry 1322 of the receive signal path and the mixer circuitry 1322 may be arranged for direct downconversion and direct upconversion, respectively. In some embodiments, the mixer circuitry 1322 of the receive signal path and the mixer circuitry 1322 of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1320 may include analog-to-digital converter (ADC) and digital-to-analog converter (DAC) circuitry and the baseband circuitry 1304 may include a digital baseband interface to communicate with the RF circuitry 1320.

In some dual-mode embodiments, a separate radio IC circuitry may be provided for processing signals for each spectrum, although the scope of the embodiments is not limited in this respect.

In some embodiments, the synthesizer circuitry 1328 may be a fractional-N synthesizer or a fractional N/N+1 synthesizer, although the scope of the embodiments is not limited in this respect as other types of frequency synthesizers may be suitable. For example, synthesizer circuitry 1328 may be a delta-sigma synthesizer, a frequency multiplier, or a synthesizer comprising a phase-locked loop with a frequency divider.

The synthesizer circuitry 1328 may be configured to synthesize an output frequency for use by the mixer circuitry 1322 of the RF circuitry 1320 based on a frequency input and a divider control input. In some embodiments, the synthesizer circuitry 1328 may be a fractional N/N+1 synthesizer.

In some embodiments, frequency input may be provided by a voltage controlled oscillator (VCO), although that is not a requirement. Divider control input may be provided by either the baseband circuitry 1304 or the application circuitry 1302 (such as an applications processor) depending on the desired output frequency. In some embodiments, a divider control input (e.g., N) may be determined from a look-up table based on a channel indicated by the application circuitry 1302.

Synthesizer circuitry 1328 of the RF circuitry 1320 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 1328 may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 1320 may include an IQ/polar converter.

The FEM circuitry 1330 may include a receive signal path which may include circuitry configured to operate on RF signals received from one or more antennas 1332, amplify the received signals and provide the amplified versions of the received signals to the RF circuitry 1320 for further processing. The FEM circuitry 1330 may also include a transmit signal path which may include circuitry configured to amplify signals for transmission provided by the RF circuitry 1320 for transmission by one or more of the one or more antennas 1332. In various embodiments, the amplification through the transmit or receive signal paths may be done solely in the RF circuitry 1320, solely in the FEM circuitry 1330, or in both the RF circuitry 1320 and the FEM circuitry 1330.

In some embodiments, the FEM circuitry 1330 may include a TX/RX switch to switch between transmit mode and receive mode operation. The FEM circuitry 1330 may include a receive signal path and a transmit signal path. The receive signal path of the FEM circuitry 1330 may include an LNA to amplify received RF signals and provide the amplified received RF signals as an output (e.g., to the RF circuitry 1320). The transmit signal path of the FEM circuitry 1330 may include a power amplifier (PA) to amplify input RF signals (e.g., provided by the RF circuitry 1320), and one or more filters to generate RF signals for subsequent transmission (e.g., by one or more of the one or more antennas 1332).

In some embodiments, the PMC 1334 may manage power provided to the baseband circuitry 1304. In particular, the PMC 1334 may control power-source selection, voltage scaling, battery charging, or DC-to-DC conversion. The PMC 1334 may often be included when the device 1300 is capable of being powered by a battery, for example, when the device 1300 is included in a UE. The PMC 1334 may increase the power conversion efficiency while providing desirable implementation size and heat dissipation characteristics.

FIG. 13 shows the PMC 1334 coupled only with the baseband circuitry 1304. However, in other embodiments, the PMC 1334 may be additionally or alternatively coupled with, and perform similar power management operations for, other components such as, but not limited to, the application circuitry 1302, the RF circuitry 1320, or the FEM circuitry 1330.

In some embodiments, the PMC 1334 may control, or otherwise be part of, various power saving mechanisms of the device 1300. For example, if the device 1300 is in an RRC_Connected state, where it is still connected to the RAN node as it expects to receive traffic shortly, then it may enter a state known as Discontinuous Reception Mode (DRX) after a period of inactivity. During this state, the device 1300 may power down for brief intervals of time and thus save power.

If there is no data traffic activity for an extended period of time, then the device 1300 may transition off to an RRC_Idle state, where it disconnects from the network and does not perform operations such as channel quality feedback, handover, etc. The device 1300 goes into a very low power state and it performs paging where again it periodically wakes up to listen to the network and then powers down again. The device 1300 may not receive data in this state, and in order to receive data, it transitions back to an RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 1302 and processors of the baseband circuitry 1304 may be used to execute elements of one or more instances of a protocol stack. For example, processors of the baseband circuitry 1304, alone or in combination, may be used to execute Layer 3, Layer 2, or Layer 1 functionality, while processors of the application circuitry 1302 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

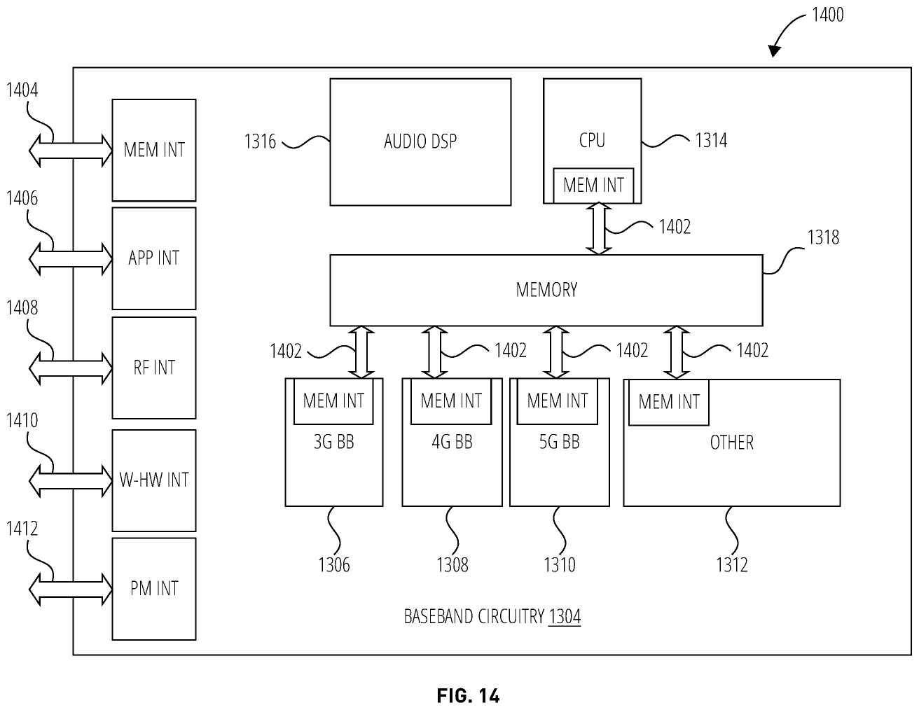

FIG. 14 illustrates example interfaces 1400 of baseband circuitry in accordance with some embodiments. As discussed above, the baseband circuitry 1304 of FIG. 13 may comprise 3G baseband processor 1306, 4G baseband processor 1308, 5G baseband processor 1310, other baseband processor(s) 1312, CPU 1314, and a memory 1318 utilized by said processors. As illustrated, each of the processors may include a respective memory interface 1402 to send/receive data to/from the memory 1318.

The baseband circuitry 1304 may further include one or more interfaces to communicatively couple to other circuitries/devices, such as a memory interface 1404 (e.g., an interface to send/receive data to/from memory external to the baseband circuitry 1304), an application circuitry interface 1406 (e.g., an interface to send/receive data to/from the application circuitry 1302 of FIG. 13), an RF circuitry interface 1408 (e.g., an interface to send/receive data to/from RF circuitry 1320 of FIG. 13), a wireless hardware connectivity interface 1410 (e.g., an interface to send/receive data to/from Near Field Communication (NFC) components, Bluetooth® components (e.g., Bluetooth® Low Energy), Wi-Fi® components, and other communication components), and a power management interface 1412 (e.g., an interface to send/receive power or control signals to/from the PMC 1334.

### IV. ADDITIONAL EXAMPLES

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The following examples pertain to further embodiments.

Example 1 is an apparatus for a test equipment (TE), the apparatus comprising a memory interface and a processor. The memory interface to send or receive, to or from a memory device, data corresponding to an operating band, a subcarrier spacing, and a channel bandwidth used to test a user equipment (UE). The processor to determine a power spectral density (Noc) for an artificial noise signal to apply to the UE for testing at the operating band, the subcarrier spacing, and the channel bandwidth based on an equation: Noc=REFSENS−10*log 10(BW)+D−SNR_{REFSENS}+X, where: REFSENS comprises a reference sensitivity power level corresponding to a receiver of the UE for the operating band, the subcarrier spacing, and the channel bandwidth; BW comprises a receive bandwidth; D comprises a diversity gain of the receiver; SNR_{REFSENS}=−1 dB corresponding to a signal-to-noise ratio (SNR) used for simulation of the REFSENS; and X comprises a desired value above a thermal noise of the UE.

Example 2 is the apparatus of Example 1, wherein the BW is determined based on a number of subcarriers in a physical resource block (PRB), the subcarrier spacing, and a maximum number of PRBs associated with the REFSENS.

Example 3 is the apparatus of Example 1, wherein the processor is further configured to select X in a range of about 15 dB to 16 dB to selectively set a total noise of about 0.1 dB.

Example 4 is an apparatus for a test equipment (TE), the apparatus comprising a memory interface and a processor. The memory interface to send or receive, to or from a memory device, data corresponding to an operating band, a subcarrier spacing, and a channel bandwidth used to test a user equipment (UE). The processor to determine a power level (Es) of a signal to apply to the UE for testing at the operating band, the subcarrier spacing, and the channel bandwidth based on an equation: Es=REFSENS−10*log 10(BW)+D−SNR_{REFSENS}+SNR_{bound}, where: REFSENS comprises a reference sensitivity power level corresponding to a receiver of the UE for the operating band, the subcarrier spacing, and the channel bandwidth; BW comprises a receive bandwidth; D comprises a diversity gain of the receiver; SNR_{REFSENS}=−1 dB corresponding to a signal-to-noise ratio (SNR) used for simulation of the REFSENS; and SNR_{bound} comprises an SNR value associated with the signal based at least in part on an error vector magnitude (EVM) of a transmitter (Tx) of the TE.

Example 5 is the apparatus of Example 4, wherein the BW is determined based on a number of subcarriers in a physical resource block (PRB), the subcarrier spacing, and a maximum number of PRBs associated with the REFSENS.

Example 6 is the apparatus of Example 4, wherein the SNR_{bound} is selected in a range of about 30 dB to 35 dB for a first frequency range (FR1).

Example 7 is an apparatus for a test equipment (TE), the apparatus comprising a memory interface and a processor. The memory interface to send or receive, to or from a memory device, data corresponding to a multi-band relaxation parameter. The processor to determine a multi-band power spectral density (Noc) for an artificial noise signal for a multi-band capable user equipment (UE) based on an equation: NocMB=NocSB+ΣMBP, where: NocMB comprises a Noc to apply to the multi-band capable UE for testing; NocSB comprises a single-band Noc corresponding to a single-band capable UE; and ΣMBP comprises the multi-band relaxation parameter corresponding to a peak effective isotropic radiated power (EIRP).

Example 8 is the apparatus of Example 7, wherein the NocMB is for wirelessly testing the multi-band UE in a second frequency range (FR2) at or above 7 GHz.

Example 9 is a method to test receiver (Rx) performance requirements of a user equipment (UE), the method comprising: generating a radio frequency (RF) signal with a power level (Es) and an artificial noise signal with a power spectral density (Noc); determining the Es for the RF signal and the Noc for the artificial noise signal, wherein the Es and the Noc are selected to emulate a target signal-to-noise ratio (SNR) at a baseband Rx chain of the UE and compensate for UE RF noise; combining the RF signal and the noise signal to produce an applied signal; and providing the applied signal to the UE.

Example 10 is the method of Example 9, wherein providing the applied signal to the UE comprises directly providing the applied signal to conducted antenna connectors of the UE for conducted testing of UE performance requirements including UE demodulation or channel state information (CSI) requirements.

Example 11 is the method of Example 10, wherein determining the Noc comprises deriving a per-band variable Noc based on a power level (PNoiseRF) of the UE RF noise.

Example 12 is the method of Example 11, wherein the per-band variable Noc produces a fixed SNR error.

Example 13 is the method of Example 11, further comprising deriving the PNoiseRF from a reference sensitivity power level (REFSENS) corresponding to a receiver of the UE.

Example 14 is the method of Example 13, wherein: PNoiseRF=REFSENS−10*log 10(BW)+D−SNRREFSENS, where REFSENS is in dBm/Hz, BW corresponds to a receive bandwidth in Hz, D comprises a diversity gain of the receiver in dB, and SNRREFSENS=−1 dB corresponding to an SNR used for simulation of the REFSENS.

Example 15 is the method of Example 14, wherein the BW is determined based on a number of subcarriers in a physical resource block (PRB), a subcarrier spacing associated with the REFSENS, and a maximum number of PRBs associated with the REFSENS.

Example 16 is the method of Example 14, wherein Noc=PNoiseRF+X, where X comprises a parameter used to selectively set a desired SNR degradation observed at the UE baseband due to UE RF noise.

Example 17 is the method of Example 16, further comprising selecting X in a range of about 15 dB to 16 dB, wherein the desired SNR degradation is about 0.1 dB.

Example 18 is the method of Example 10, wherein determining the Noc comprises setting the Noc to zero to emulate noise free conditions, the method further selecting a band specific value for the Es based on a power level (PNoiseRF) of the UE RF noise.

Example 19 is the method of Example 18, wherein Es=PNoiseRF+SNRbound, where SNRbound comprises an SNR value associated with the applied signal based at least in part on an error vector magnitude (EVM) of a test equipment (TE) transmitter (Tx).

Example 20 is the method of Example 19, further comprising selecting SNRbound in a range of about 30 dB to 35 dB for first frequency range (FR1).

Example 21 is the method of Example 9, wherein the RF signal is within a second frequency range (FR2), and wherein providing the applied signal to the UE comprises wirelessly transmitting the applied signal to the UE in a test equipment (TE) chamber for radiated testing of demodulation or channel state information (CSI) requirements.

Example 22 is the method of Example 21, wherein the UE supports operation in multiple FR2 bands, and wherein determining the Noc comprises determining a Noc for multi-band capable devices (NocMB) such that: NocMB=NocSB+ΣMBP, where NocSB comprises a single-band Noc corresponding to single-band capable devices, and ΣMBP comprises a multi-band relaxation parameter corresponding to a peak effective isotropic radiated power (EIRP).

Any of the above described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

It should be recognized that the systems described herein include descriptions of specific embodiments. These embodiments can be combined into single systems, partially combined into other systems, split into multiple systems or divided or combined in other ways. In addition, it is contemplated that parameters/attributes/aspects/etc. of one embodiment can be used in another embodiment. The parameters/attributes/aspects/etc. are merely described in one or more embodiments for clarity, and it is recognized that the parameters/attributes/aspects/etc. can be combined with or substituted for parameters/attributes/etc. of another embodiment unless specifically disclaimed herein.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. An apparatus for a test equipment (TE), the apparatus comprising:
a memory interface to send or receive, to or from a memory device, data corresponding to an operating band, a subcarrier spacing, and a channel bandwidth used to test a user equipment (UE); and
a processor to determine a power spectral density (Noc) for an artificial noise signal to apply to the UE for testing at the operating band, the subcarrier spacing, and the channel bandwidth based on an equation:
Noc=REFSENS−10*log 10(BW)+D−SNRREFSENS+X,
where:
REFSENS comprises a reference sensitivity power level corresponding to a receiver of the UE for the operating band, the subcarrier spacing, and the channel bandwidth;
BW comprises a receive bandwidth;
D comprises a diversity gain of the receiver;
SNRREFSENS=−1 dB corresponding to a signal-to-noise ratio (SNR) used for simulation of the REFSENS; and
X comprises a desired value above a thermal noise of the UE.

2. The apparatus of claim 1, wherein the BW is determined based on a number of subcarriers in a physical resource block (PRB), the subcarrier spacing, and a maximum number of PRBs associated with the REFSENS.

3. The apparatus of claim 1, wherein the processor is further configured to select X in a range of about 15 dB to 16 dB to selectively set a total noise of about 0.1 dB.

4. An apparatus for a test equipment (TE), the apparatus comprising:
a memory interface to send or receive, to or from a memory device, data corresponding to an operating band, a subcarrier spacing, and a channel bandwidth used to test a user equipment (UE); and
a processor to determine a power level (Es) of a signal to apply to the UE for testing at the operating band, the subcarrier spacing, and the channel bandwidth based on an equation:
Es=REFSENS−10*log 10(BW)+D−SNRREFSENS+SNRbound,
where:
REFSENS comprises a reference sensitivity power level corresponding to a receiver of the UE for the operating band, the subcarrier spacing, and the channel bandwidth;
BW comprises a receive bandwidth;
D comprises a diversity gain of the receiver;
SNRREFSENS=−1 dB corresponding to a signal-to-noise ratio (SNR) used for simulation of the REFSENS; and
SNRbound comprises an SNR value associated with the signal based at least in part on an error vector magnitude (EVM) of a transmitter (Tx) of the TE.

5. The apparatus of claim 4, wherein the BW is determined based on a number of subcarriers in a physical resource block (PRB), the subcarrier spacing, and a maximum number of PRBs associated with the REFSENS.

6. The apparatus of claim 4, wherein the SNRbound is selected in a range of about 30 dB to 35 dB for a first frequency range (FR1).

7-8. (canceled)

9. A method to test receiver (Rx) performance requirements of a user equipment (UE), the method comprising:
generating a radio frequency (RF) signal with a power level (Es) and an artificial noise signal with a power spectral density (Noc);
determining the Es for the RF signal and the Noc for the artificial noise signal, wherein the Es and the Noc are selected to emulate a target signal-to-noise ratio (SNR) at a baseband Rx chain of the UE and compensate for UE RF noise;
combining the RF signal and the artificial noise signal to produce an applied signal; and
providing the applied signal to the UE.

10. The method of claim 9, wherein providing the applied signal to the UE comprises directly providing the applied signal to conducted antenna connectors of the UE for conducted testing of UE performance requirements including UE demodulation or channel state information (CSI) requirements.

11. The method of claim 10, wherein determining the Noc comprises deriving a per-band variable Noc based on a UE RF noise power level (PNoiseRF) of the UE RF noise.

12. The method of claim 11, wherein the per-band variable Noc produces a fixed SNR error.

13. The method of claim 11, further comprising deriving the PNoiseRF from a reference sensitivity power level (REFSENS) corresponding to a receiver of the UE.

14. The method of claim 13, wherein:
PNoiseRF=REFSENS−10*log 10(BW)+D−SNRREFSENS,
where
REFSENS is in dBm/Hz,
BW corresponds to a receive bandwidth in Hz,
D comprises a diversity gain of the receiver in dB, and
SNRREFSENS=−1 dB corresponding to an SNR used for simulation of the REFSENS.

15. The method of claim 14, wherein the BW is determined based on a number of subcarriers in a physical resource block (PRB), a subcarrier spacing associated with the REFSENS, and a maximum number of PRBs associated with the REFSENS.

16. The method of claim 14, wherein the Noc=PNoiseRF+X, where X comprises a parameter used to selectively set a desired SNR degradation observed at the UE baseband due to UE RF noise.

17. The method of claim 16, further comprising selecting X in a range of about 15 dB to 16 dB, wherein the desired SNR degradation is about 0.1 dB.

18. The method of claim 10, wherein determining the Noc comprises setting the Noc to zero to emulate noise free conditions, the method further selecting a band specific value for the Es based on a UE RF noise power level (PNoiseRF) of the UE RF noise.

19. The method of claim 18, wherein Es=PNoiseRF+SNRbound, where SNRbound comprises an SNR value associated with the applied signal based at least in part on an error vector magnitude (EVM) of a test equipment (TE) transmitter (Tx).

20. The method of claim 19, further comprising selecting SNRbound in a range of about 30 dB to 35 dB for first frequency range (FR1).

21. The method of claim 9, wherein the RF signal is within a second frequency range (FR2), and wherein providing the applied signal to the UE comprises wirelessly transmitting the applied signal to the UE in a test equipment (TE) chamber for radiated testing of demodulation or channel state information (CSI) requirements.

22. The method of claim 21, wherein the UE supports operation in multiple FR2 bands, and wherein determining the Noc comprises determining a Noc for multi-band capable devices (NocMB) such that:
NocMB=NocSB+ΣMBP,
where
NocSB comprises a single-band Noc corresponding to single-band capable devices, and
ΣMBP comprises a multi-band relaxation parameter corresponding to a peak effective isotropic radiated power (EIRP).
